(19) United States
(12) Patent Application Publication
(10) Pub. No.: US 2016/0183147 A1
(43) Pub. Date: Jun. 23, 2016

(54) REPORTING BETWEEN BASE STATIONS

(71) Applicant: TELEFONAKTIEBOLAGET L M ERICSSON (PUBL), Stockholm (SE)

(72) Inventors: Icaro L. J. DA SILVA, Bromma (SE); Angelo CENTONZA, Winchester (GB); Oumer TEYEB, Solna (SE); Filip MESTANOV, Sollentuna (SE)

(21) Appl. No.: 14/910,542

(22) PCT Filed: Jun. 12, 2014
(86) PCT No.: PCT/SE2014/050710

§ 371 Date: Feb. 5, 2016

Related U.S. Application Data
(60) Provisional application No. 61/864,152, filed on Aug. 9, 2013.

(51) Int. Cl. H04W 36/22; H04W 36/00

(52) U.S. Cl. CPC H04W 36/22; H04W 36/0055; H04W 84/12

(57) ABSTRACT

Methods may be provided to operate a source base station of a radio access network providing wireless communications for a plurality of wireless terminals. According to one embodiment, information may be received at the source base station regarding at least one wireless access point providing service within a coverage area of at least one neighbor base station of the radio access network. In further embodiments, one or more of the plurality of wireless terminals may be handed over from the source base station to the at least one neighbor base station based on the information regarding the at least one wireless access point.

### TECHNICAL FIELD

The technology described relates to base stations and methods of operating base stations of radio access networks.

### BACKGROUND

A Rel. 12 study item on “Next-Generation SON for UTRA and LTE” (RP-122037, “Study on Next Generation SON for UTRA and LTE”) includes an aspect entitled “SON for UE types” proposing to investigate if SON features specified so far could benefit from knowledge about UE types.

Mobility Load Balancing (MLB) is one of the candidate use cases that might benefit from UE grouping strategies (i.e., a source cell deciding to offload a group of users based on some criteria to a target cell whose load information is known.

Currently, 3GPP (3^{rd} Generation Partnership Project) specifies the following components for MLB (Mobility Load Balancing) solutions:
Load reporting (not the same for intra-LTE and inter-RAT in terms of: Load measures, Reporting Procedures);
Load balancing action based on handovers (HOs); and/or
Adapting HO/cell reselection (CR) configuration so that the load remains balanced.

To perform a proper grouping strategy, in a dynamic way, a source eNB (also referred to as a source base station or source cell) should have enough information about its neighbor eNBs (also referred to as neighbor base stations or neighbor cells) and UE's (also referred to as user equipment nodes or wireless terminals) to judge where (which cell) and who (which group of UE's) should be handed over. Part of this may be a responsibility of a Load reporting function.

This load reporting function relates to load measures and reporting procedures of load information requested/exchanged between eNBs. The load reporting function is executed by exchanging cell-specific load information between neighbor eNBs over the X2 (intra-LTE scenario) or S1 (inter-RAT scenario) interfaces.

In parallel with this Study item in RAN3 about UE grouping, there is a RAN2 Study Item on RAN-WLAN integration (RP-122038: New Study Item Proposal on WLAN/3GPP Radio Interworking, Intel Corporation) which aims to study procedures and reports to enable proper access selection between WLAN and 3GPP networks. In this context, solutions have been proposed to establish a relation between mobility functions of a given LTE (Long Term Evolution) eNB and WLAN (Wireless Local Area Network) AP (Access Point) so that these two nodes could exchange different kinds of information about each other. The load reporting function is executed by exchanging cell specific load information between neighbor eNBs over the X2 (intra-LTE scenario) or S1 (inter-RAT scenario) interfaces where two procedures are involved: the Resource Status Initiation X2 procedure, and the Resource Status Reporting X2 procedure, as highlighted in FIG. 2 and FIG. 3:

FIG. 2—X2 Load exchange procedures for MLB; and

FIG. 3—X2 Load exchange procedures for MLB.

As shown in FIG. 2, base station eNB1 sends “2-1. Resource Status Request” messages to neighbor base stations eNB2 and eNB3, and neighbor base stations eNB2 and eNB3 respond periodically (e.g., every 1 to 10 seconds) with “2-2. Resource Status Update” messages. As shown in FIG. 3, a resource status initiation X2 procedure may be initiated when a load is greater than a threshold (Lte_load_threshold) in cell A1 (eNB1), and a resource status update X2AP message may be reported with a periodicity of 1 to 10 seconds and/or when a load measure is to be reported. In addition, a resource status reporting X2 procedure and/or a resource status update X2AP message may be used.

Once the source eNB has decided the target eNB and which UE's will be handed over to the target eNB, the source eNB may perform a Mobility Parameter Change Procedure followed by ordinary handovers, as illustrated in FIG. 4. FIG. 4 illustrates mobility load balancing MLB execution, including a Mobility Parameter Change procedure. Responsive to base station eNB1 detecting overload at block 401, base station eNB 1 may transmit resource status request message 403, and neighbor base station eNB2 may respond with a resource status response message 405 and a resource status update message 407. Responsive to the resource status update message 407, base station eNB 1 may find (identify) a cell/UE candidate(s) for load balancing handover at block 409. As indicated by the handover procedure arrow, base station eNB1 may initiate the handover procedure, indicating the cause value for the handover to be “load balancing”. The base station eNB1 may also send a mobility change request (MCR) message 411 to change the mobility parameter settings between the cells of eNB1 and eNB2. If the proposed mobility parameter settings are not acceptable by eNB2, eNB2 responds by sending a Mobility Change Failure message 413, with an indication of the range of acceptable mobility parameters. Responsive to receiving a mobility change failure message 413 from target base station eNB2, base station eNB1 may send a second MCR message 415, and after receiving a Mobility Change Acknowledge message 417 from target base station eNB2, both base stations eNB1 and eNB2 may change handover settings at blocks 419.

### SUMMARY

It may therefore be an object to address at least some of the above mentioned disadvantages and/or to improve performance in a wireless communication system.

According to some embodiments disclosed herein, methods may be provided to operate a source base station of a radio access network providing wireless communications for a plurality of wireless terminals. More particularly, the source base station may receive information regarding at least one wireless access point providing service within a coverage area of at least one neighbor base station of the radio access network. Moreover, the information may be received from the at least one neighbor base station of the radio access network.

The source base station may thus use the information regarding wireless access points operating in coverage areas of neighbor base stations to decide how/where to offload wireless terminals, for example, to support mobility load balancing when a load/traffic being handled by the source base station exceeds a threshold. The source base station can thus hand over one or more of the plurality of wireless terminals from the source base station to the at least one neighbor base station based on the information regarding the at least one wireless access point. Handing over, for example, may include handing over one or more of the plurality of wireless terminals from the source base station to the at least one neighbor base station based on the information regarding the at least one wireless access point responsive to a load of the source base station exceeding a threshold.

Receiving the information may include receiving the information from the at least one neighbor base station of the radio access network.

The plurality of wireless terminals may include a first plurality of wireless terminals that are WLAN capable and a second plurality of wireless terminals that are non-WLAN capable. Receiving the information may include receiving a first report from a first neighbor base station including information identifying a wireless WLAN access point and receiving a second report from a second neighbor base station identifying no wireless WLAN access points. Handing over may include handing over the first plurality of wireless terminals that are WLAN capable to the first neighbor base station and handing over the second plurality of wireless terminals that are non-WLAN capable to the second neighbor base station.

The plurality of wireless terminals may include a first plurality of wireless terminals having a first WLAN capability (e.g., according to a first capability of the WiFi standard) and a second plurality of wireless terminals having a second WLAN capability (e.g., according to a second capability of the WiFi standard) different than the first WLAN capability. Receiving the information may include receiving a first report from a first neighbor base station including information identifying a wireless WLAN access point supporting the first WLAN capability and receiving a second report from a second neighbor base station identifying a wireless WLAN access point supporting the second WLAN capability. Handing over may include handing over the first plurality of wireless terminals to the first neighbor base station and handing over the second plurality of wireless terminals to the second neighbor base station.

The plurality of wireless terminals may have a WLAN capability (e.g., according to a WiFi standard), and receiving the information may include receiving a first report from a first neighbor base station including information identifying a first wireless WLAN access point and receiving a second report from a second neighbor base station identifying a second wireless WLAN access point wherein a reported load of the second WLAN access point is higher than a reported load of the first WLAN access point. Handing over may include prioritizing handing over the wireless terminals that have the WLAN capability to the first neighbor base station.

The information regarding the at least one wireless access point may include a location of a wireless access point providing service within the coverage area of the at least one neighbor base station.

The information regarding the at least one wireless access point may include a capacity and/or bandwidth of a wireless access point providing service within the coverage area of the at least one neighbor base station.

The information regarding the at least one wireless access point may include an extended service set identifier for a plurality of wireless access points providing continuous service.

The information regarding the at least one wireless access point may include an operating frequency and/or channel number of a wireless access point providing service within the coverage area of the at least one neighbor base station.

The information regarding the at least one wireless access point may include an identifier for a wireless access point providing service within the coverage area of the at least one neighbor base station.

The information regarding the at least one wireless access point may include a load (e.g., a wireless terminal population and/or data traffic level) being serviced by a wireless access point providing service within the coverage area of the at least one neighbor base station.

The radio access network may be a Long Term Evolution (LTE) radio access network, the source base station may be a first LTE eNodeB base station, and the at least one neighbor base station may be a second LTE eNodeB base station.

The at least one wireless access point may be at least one WLAN access point.

In addition, a report may be transmitted to the at least one neighbor base station, and the report may include the information regarding at least one wireless access point providing service within a coverage area of the source base station.

Moreover, information regarding at least one wireless access point providing service within a coverage area of the source base station may be transmitted to another base station of the radio access network.

The source base station and the at least one neighbor base station may operate according to a first radio access technology while the at least one wireless access point operates according to a second radio access technology.

According to some other embodiments disclosed herein, methods may be provided to operate a source base station of a radio access network providing wireless communications for a plurality of wireless terminals. More particularly, one or more of the plurality of wireless terminals may be handed over from the source base station to at least one neighbor base station based on information regarding at least one wireless access point providing service within a coverage area of the at least one neighbor base station.

Moreover, the information regarding the at least one wireless access point may be received from the at least one neighbor base station of the radio access network.

Handing over may include handing over one or more of the plurality of wireless terminals from the source base station to the at least one neighbor base station responsive to a load of the source base station exceeding a threshold and responsive to the information regarding the at least one wireless access point.

In addition, information regarding at least one wireless access point providing service within a coverage area of the source base station may be transmitted to another base station of the radio access network.

According to still other embodiments disclosed herein, a base station of a radio access network may include a transceiver, a processor coupled to the transceiver, and memory coupled to the processor. The transceiver may be configured to provide communications for a plurality of wireless terminals in a coverage area of the base station. The processor may be configured to receive information regarding at least one wireless access point providing service within a coverage area of at least one neighbor base station of the radio access network. The memory may be configured to store the information regarding the at least one wireless access point providing service within the coverage area of the at least one neighbor base station.

The processor may be further configured to hand over one or more of the plurality of wireless terminals from the base station to the at least one neighbor base station based on the information regarding the at least one wireless access point.

The processor may be configured to hand over one or more of the plurality of wireless terminals from the base station to the at least one neighbor base station based on the information regarding the at least one wireless access point responsive to a load of the base station exceeding a threshold.

The processor may be configured to receive the information from the at least one neighbor base station of the radio access network (e.g., over an X2 interface).

The plurality of wireless terminals may include a first plurality of wireless terminals that are WLAN capable and a second plurality of wireless terminals that are non-WLAN capable. The processor may be configured to receive a first report from a first neighbor base station including information identifying a wireless WLAN access point and to receive a second report from a second neighbor base station identifying no wireless WLAN access points. Moreover, the processor may be configured to hand over the first plurality of wireless terminals that are WLAN capable to the first neighbor base station and to hand over the second plurality of wireless terminals that are non-WLAN capable to the second neighbor base station.

The plurality of wireless terminals may include a first plurality of wireless terminals having a first WLAN capability (e.g., according to a first capability of the WiFi standard) and a second plurality of wireless terminals having a second WLAN capability (e.g., according to a second capability of the WiFi standard) different than the first WLAN capability. The processor may be configured to receive a first report from a first neighbor base station including information identifying a wireless WLAN access point supporting the first WLAN capability and to receive a second report from a second neighbor base station identifying a wireless WLAN access point supporting the second WLAN capability. Moreover, the processor may be configured to hand over the first plurality of wireless terminals to the first neighbor base station and to hand over the second plurality of wireless terminals to the second neighbor base station.

The plurality of wireless terminals may include a first plurality of wireless terminals having a WLAN capability and a second plurality of wireless terminals having a WLAN capability. The processor may be configured to receive a first report from a first neighbor base station including information identifying a wireless WLAN access point that is lightly loaded and to receive a second report from a second neighbor base station identifying a wireless WLAN access point that is heavily loaded. The processor may be configured to prioritize handing over the first plurality of wireless terminals to the first neighbor base station.

The plurality of wireless terminals may have a WLAN capability, and the processor may be configured to receive a first report from a first neighbor base station and a second report from a second neighbor base station. The first report may include information identifying a wireless WLAN access point that is lightly loaded, and the second report may include information identifying a wireless WLAN access point that is heavily loaded. The processor may be configured to prioritize handing over the plurality of wireless terminals to the first neighbor base station.

According to yet other embodiments disclosed herein, a base station of a radio access network may include a transceiver and a processor coupled to the transceiver. The transceiver may be configured to provide communications for a plurality of wireless terminals in a coverage area of the base station. The processor may be configured to hand over one or more of the plurality of wireless terminals from the base station to at least one neighbor base station based on information regarding at least one wireless access point providing service within a coverage area of the at least one neighbor base station.

The processor may be further configured to receive the information regarding the at least one wireless access point from the at least one neighbor base station of the radio access network.

The processor may be configured to hand over one or more of the plurality of wireless terminals from the base station to the at least one neighbor base station responsive to a load of the base station exceeding a threshold and responsive to the information regarding the at least one wireless access point.

The processor may be further configured to transmit information regarding at least one wireless access point providing service within a coverage area of the base station to another base station of the radio access network.

According to further embodiments disclosed herein, a base station of a radio access network for providing wireless communications for a plurality of wireless terminals. The base station may be adapted to receive at the base station information regarding at least one wireless access point providing service within a coverage area of at least one neighbor base station of the radio access network.

The base station may be further adapted to hand over one or more of the plurality of wireless terminals from the base station to the at least one neighbor base station based on the information regarding the at least one wireless access point.

The base station may be adapted to hand over one or more of the plurality of wireless terminals from the base station to the at least one neighbor base station based on the information regarding the at least one wireless access point responsive to a load of the source base station exceeding a threshold.

The base station may be adapted to receive the information from the at least one neighbor base station of the radio access network.

The plurality of wireless terminals may include a first plurality of wireless terminals that are WLAN capable and a second plurality of wireless terminals that are non-WLAN capable. Receiving the information may include receiving a first report from a first neighbor base station including information identifying a wireless WLAN access point and receiving a second report from a second neighbor base station identifying no wireless WLAN access points. The base station may be adapted to hand over the first plurality of wireless terminals that are WLAN capable to the first neighbor base station and to hand over the second plurality of wireless terminals that are non-WLAN capable to the second neighbor base station.

The plurality of wireless terminals may include a first plurality of wireless terminals having a first WLAN capability and a second plurality of wireless terminals having a second

WLAN capability different than the first WLAN capability. Receiving the information may include receiving a first report from a first neighbor base station including information identifying a wireless WLAN access point supporting the first WLAN capability and receiving a second report from a second neighbor base station identifying a wireless WLAN access point supporting the second WLAN capability. The base station may be adapted to hand over the first plurality of wireless terminals to the first neighbor base station and to hand over the second plurality of wireless terminals to the second neighbor base station.

The plurality of wireless terminals may have a WLAN capability. Receiving the information may include receiving a first report from a first neighbor base station including information identifying a first wireless WLAN access point and receiving a second report from a second neighbor base station identifying a second wireless WLAN access point. A reported load of the second WLAN access point may be higher than a reported load of the first WLAN access point. The base station may be adapted to hand over the wireless terminals that have the WLAN capability to the first neighbor base station.

The information regarding the at least one wireless access point may include a location of a wireless access point providing service within the coverage area of the at least one neighbor base station.

The information regarding the at least one wireless access point may include a capacity and/or bandwidth of a wireless access point providing service within the coverage area of the at least one neighbor base station.

The information regarding the at least one wireless access point may include an extended service set identifier for a plurality of wireless access points providing continuous service.

The information regarding the at least one wireless access point may include an operating frequency and/or channel number of a wireless access point providing service within the coverage area of the at least one neighbor base station.

The information regarding the at least one wireless access point may include an identifier for a wireless access point providing service within the coverage area of the at least one neighbor base station.

The information regarding the at least one wireless access point may include a load being serviced by a wireless access point providing service within the coverage area of the at least one neighbor base station.

The radio access network may include a Long Term Evolution, LTE, radio access network. The base station may be a first LTE eNodeB base station, and the at least one neighbor base station may be a second LTE eNodeB base station.

The at least one wireless access point may include at least one WLAN access point.

The base station may be further adapted to transmit information regarding at least one wireless access point providing service within a coverage area of the base station to another base station of the radio access network.

The base station and the at least one neighbor base station may operate according to a first radio access technology while the at least one wireless access point may operate according to a second radio access technology.

According to more embodiments disclosed herein, a base station of a radio access network for providing wireless communications for a plurality of wireless terminals. The base station may be adapted to hand over one or more of the plurality of wireless terminals from the base station to at least one neighbor base station based on information regarding at least one wireless access point providing service within a coverage area of the at least one neighbor base station.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1 is a schematic diagram illustrating load reporting between base stations;

FIG. 2 is a schematic diagram illustrating load exchange procedures for mobility load balancing;

FIG. 3 is a graph illustrating load exchange procedures for mobility load balancing;

FIG. 4 is a message diagram illustrating mobility load balancing including mobility parameter change procedures;

FIG. 5 is a block diagram illustrating management system architectures;

FIG. 6 is a schematic diagram illustrating signaling interactions for connected mode 3GPP/WLAN interworking;

FIG. 7 is a block diagram illustrating nodes, technologies, and messages according to some embodiments disclosed herein;

FIGS. 8, 9, and 10 are schematic diagrams illustrating base station operations according to some embodiments disclosed herein;

FIGS. 11A and 11B provide a table illustrating an example of an enhanced X2 setup request used to communicate WLAN information according to some embodiments disclosed herein;

FIGS. 12A and 12B provide a table illustrating an example of an enhanced X2 setup response used to communicate WLAN information according to some embodiments disclosed herein;

FIGS. 13A, 13B, 13C, 13D, 13E, 13F, and 13G provide a table illustrating an example of a served WLAN cell information element (IE) that shows detailed information according to some embodiments disclosed herein;

FIGS. 14A and 14B provide a table illustrating an example of an eNB configuration update message used to communicate additions/modification/deletion of WLAN cells/APs within eNB cells according to some embodiments disclosed herein;

FIGS. 15A and 15B provide a table illustrating an example of a modified resource status request message used to request reporting of inter RAT load according to some embodiments disclosed herein;

FIGS. 16A and 16B provide a table illustrating information elements (IEs) in a response message used to report non-3GPP system load according to some embodiments disclosed herein;

FIG. 17 provides a table illustrating an example of information elements (IEs) in the update message used to report WLAN load according to some embodiments disclosed herein;

FIGS. 18A and 18B provide a table illustrating an example of a way to encode a Cell Load IE according to some embodiments disclosed herein;

FIG. 19 provides a table illustrating an example of an encoding of a cell load information element (IE) according to some embodiments disclosed herein;

FIGS. 20A and 20B provide a table illustrating an example of an information element in a resource status failure message according to some embodiments disclosed herein;

FIG. 21 is a block diagram illustrating base stations and WLAN access points according to some embodiments disclosed herein; and

FIGS. 22A and 22B are flow charts illustrating base station operations according to some embodiments disclosed herein.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of inventive concepts to those skilled in the art. It should also be noted that these embodiments are not mutually exclusive. Components from one embodiment may be tacitly assumed to be present/used in another embodiment.

For purposes of illustration and explanation only, these and other embodiments of inventive concepts are described herein in the context of operating in a Radio Access Network (RAN) that communicates over radio communication channels with wireless terminals (also referred to as UEs). It will be understood, however, that inventive concepts are not limited to such embodiments and may be embodied generally in any type of communication network. As used herein, a legacy or non-legacy wireless terminal (also referred to as a UE) can include any device that receives data from a communication network, and may include, but is not limited to, a mobile telephone (“cellular” telephone), laptop/portable computer, pocket computer, hand-held computer, and/or desktop computer.

According to some embodiments of inventive concepts, Wi-Fi WLAN integration and UE grouping for Mobility Balancing may be combined. With such integration, a source base station (e.g., a eNB-s) may detect that it is overloaded and may send an X2AP RESOURCE STATUS REQUEST to its neighbor base stations (also referred to as target eNBs or target base stations). The potential target eNBs receiving these requests should respond by sending X2AP RESOURCE STATUS UPDATEs (with a configured periodicity). These updates may include the following load information:
a. Radio resource usage (UL/DL GBR PRB usage, UL/DL non-GBR PRB usage, UL/DL total PRB usage);
b. HW (Hardware) load indicator (UL/DL HW load: low, mid, high, overload);
c. TNL (Transport Network Level) load indicator (UL/DL TNL load: low, mid, high, overload);
d. (Optionally) Cell Capacity Class value (UL/DL relative capacity indicator: the same scale shall apply to EUTRAN, UTRAN and GERAN cells when mapping cell capacities on this value); and
e. Capacity value (UL/DL available capacity for load balancing as percentage of total cell capacity) also called CAC (composite available capacity).
   In future scenarios, base stations eNBs may be upgraded with a WLAN/3GPP access selection feature, making them capable of offloading WLAN capable UEs to non-overloaded WLAN APs within the same coverage area. It might be the case that source base station eNB-s (the source eNB) could work as an access selection controller for a given set of APs within its coverage area.

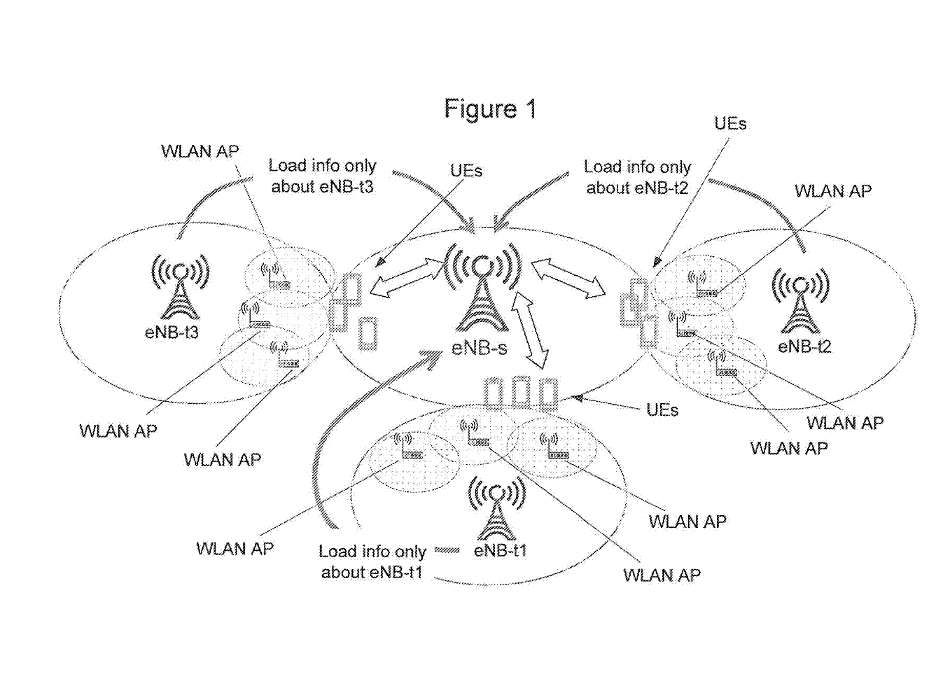

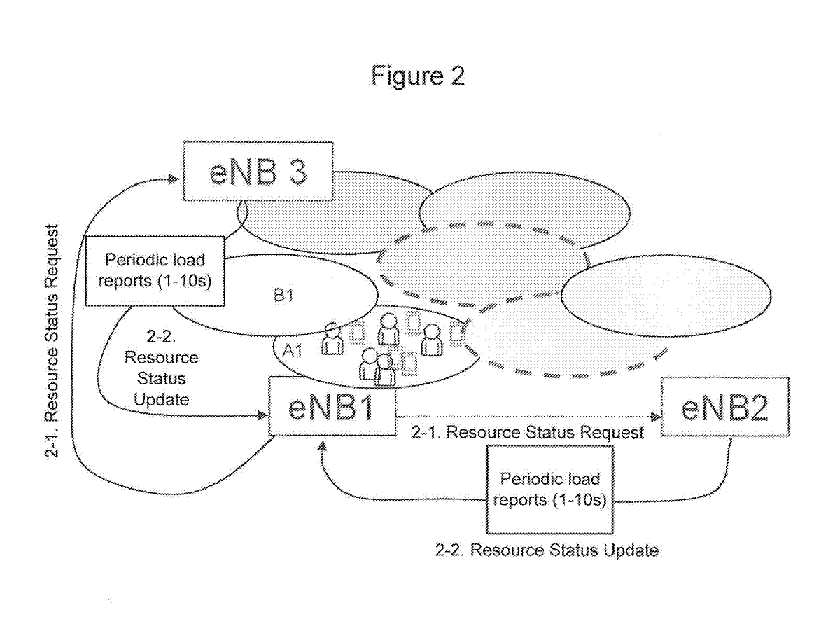

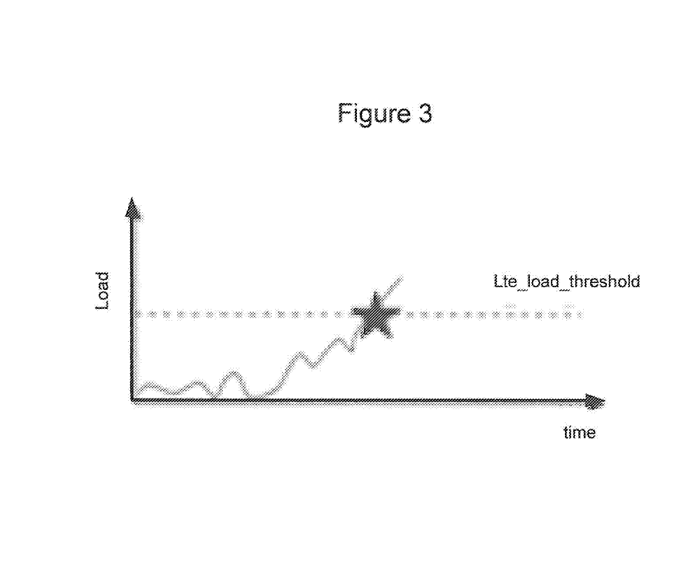

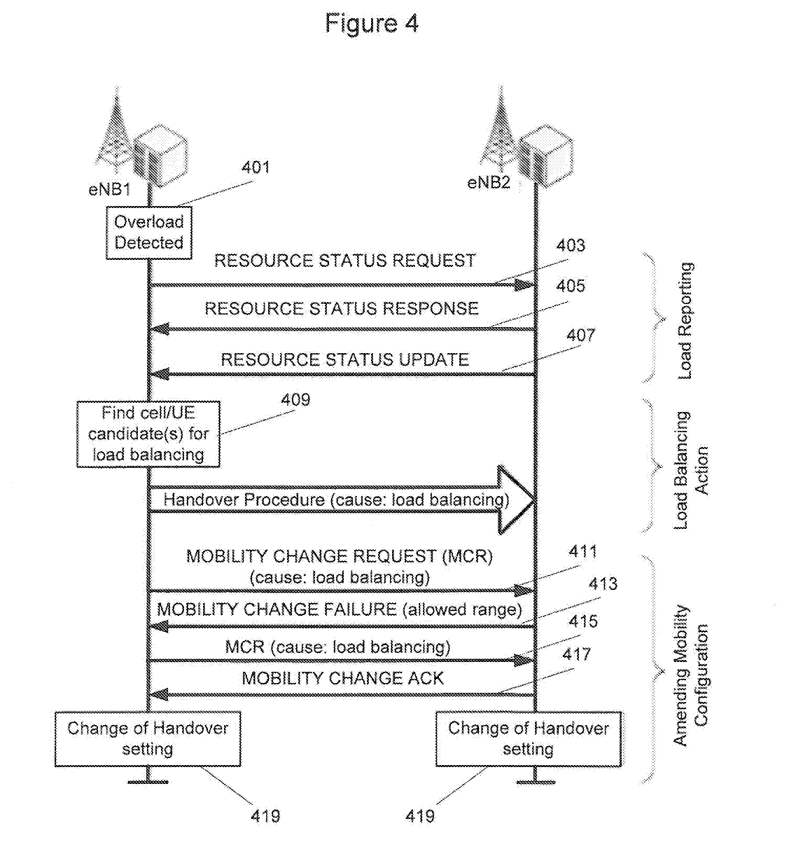

According to some embodiments, an overloaded source base station eNB-s (in response to a load X2AP RESOURCE STATUS REQUEST sent to its neighbor base stations eNB-t1, eNB-t2, and eNB-t3) may also receive information regarding:
the existence of WLAN AP's within the same coverage area(s) of its neighbors; and/or
the capabilities of WLAN AP's within the same coverage area(s) of its neighbors; and/or
the conditions of WLAN AP's (wireless local area network access points) within the same coverage area(s) of its neighbors.
   During an overloading event, the eNB-s may thus know what the current load of these APs is. As shown in FIG. 1, load reporting may not necessarily include WLAN (also referred to as Wi-Fi) information, but such information may be included according to some embodiments, for example, to increase efficiency of mobility load balancing operations.

OAM Architecture

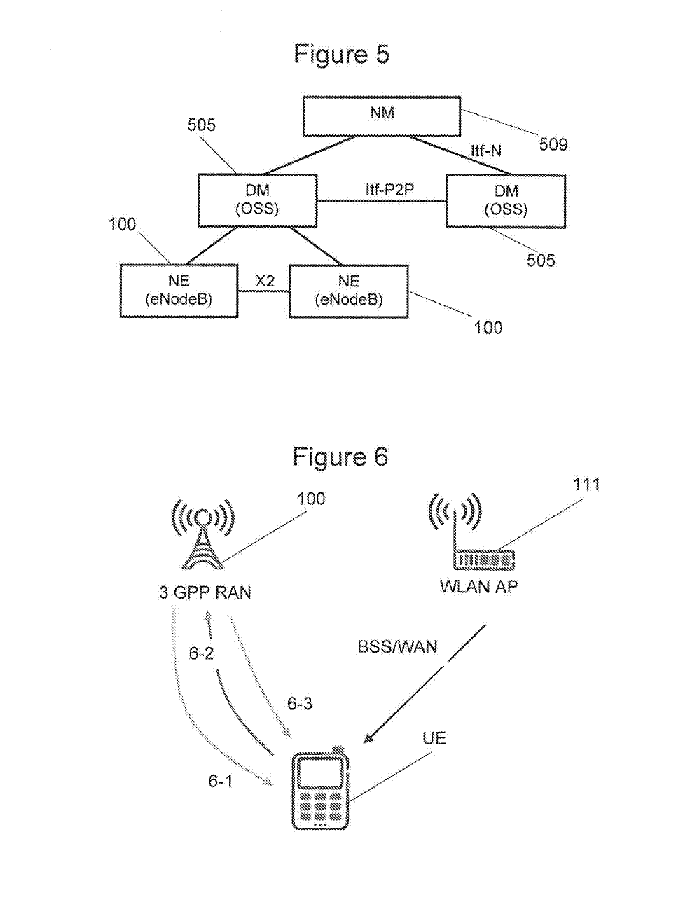

An example of a management system architecture that may be used according to some embodiments disclosed herein is illustrated in FIG. 5. The node elements NE (also referred to as eNodeBs or base stations) 100, are managed by a respective domain manager DM (also referred to as the operation and support system or OSS) 505. A DM may further be managed by a network manager NM 509. Two NEs may be interfaced using an X2 interface, whereas the interface between two DMs may be referred to as Itf-P2P interface. The management system may configure the network elements, as well as receive observations associated with features in the network elements. For example, a DM observes and configures NEs, while an NM observes and configures one or more DMs, as well as NEs via a DM. FIG. 5 illustrates an assumed management system architecture.

According to some embodiments disclosed herein, any function that automatically improves/optimizes NE parameters can in principle execute in an NE, a DM, and/or a NM. Such features are referred to as Self-Organizing Network (SON) features.

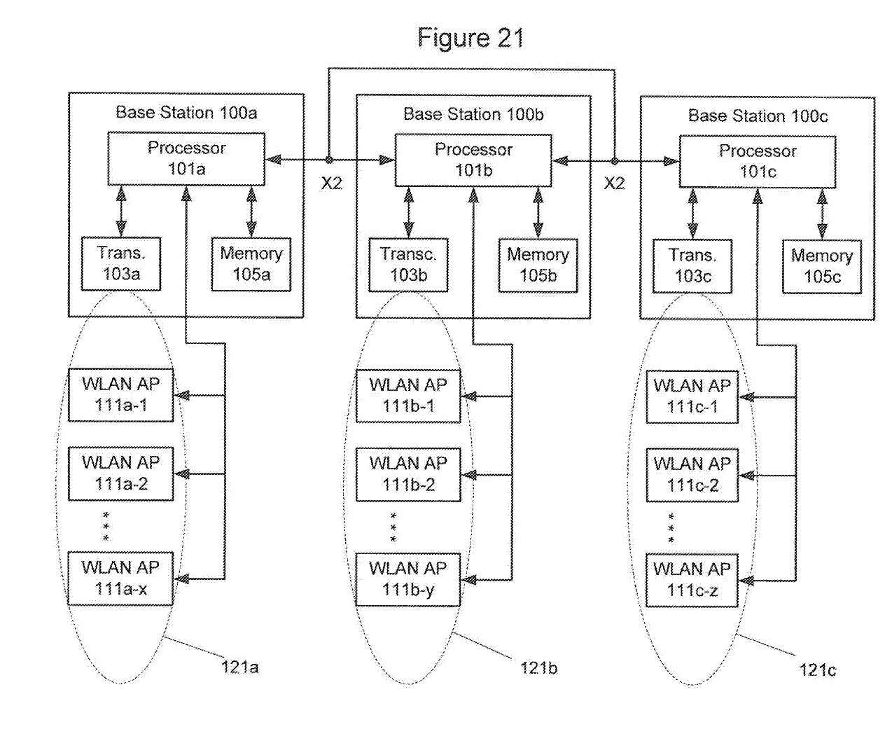

FIG. 21 is a block diagram illustrating base stations (also referred to as an NEs, eNBs, eNodeBs, etc.) 100a, 100b, and 100c of a radio access network coupled to respective WLAN Access Points (APs or WLAN APs), 111a, 111b, and 111c according to some embodiments. As shown, each base station 100a, 100b, and 100c may include a respective processor 101a, 101b, and 101c coupled to a respective transceiver 103a, 103b, and 103c and to a respective memory 105a, 105b, and 105c. In addition, base station processors 101a, 101b, and 101c may be coupled, for example, over an X2 interface(s), and WLAN access points 111 (providing wireless service over respective pico coverage areas or cells) may be provided in macro coverage areas or cells 121a, 121b, or 121c of respective base stations 100a, 100b, and 100c.

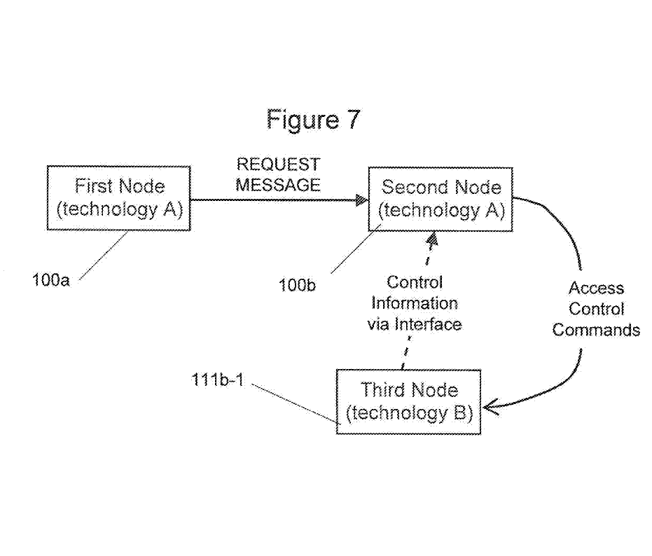

More particularly, a base station transceiver 103 may transmit/receive communications over a wireless channel(s) within a coverage area or cell 121 defined by the transceiver 103 to support communications with a plurality of wireless terminals or UEs. Accordingly, WLAN APs 111a-1 to 111a-x (also referred to as pico nodes) may provide WLAN service for wireless terminals or UEs within respective pico cells smaller than cell 121a defined by transceiver 103a, WLAN APs 111b-1 to 111b-y (also referred to as pico cells) may provide WLAN service within respective pico cells smaller than cell 121b defined by transceiver 103b, and WLAN APs 111c-1 to 111c-z (also referred to as pico cells) may provide WLAN service within respective pico cells smaller than cell 121c defined by transceiver 103c. As further shown in FIG. 21, information regarding WLAN APs 111a-1 to 111a-x may be provided to processor 101a of base station 100a (e.g., over a backhaul coupling), information regarding WLAN APs 111b-1 to 111b-y may be provided to processor 101b of base station 100b (e.g., over a backhaul coupling), and information regarding WLAN APs 111c-1 to 111c-z may be provided to processor 101c of base station 100c (e.g., over a backhaul coupling), for example, as discussed below with respect to FIG. 7. Information regarding WLAN APs operating within a coverage area of a base station 100 may thus be stored in base station memory 105. Base stations 100 may thus operate according to a first radio access technology (also referred to as technology A) such as LTE, and WLAN APs may operate according to a second radio access technology (also referred to as technology B) such as WiFi.

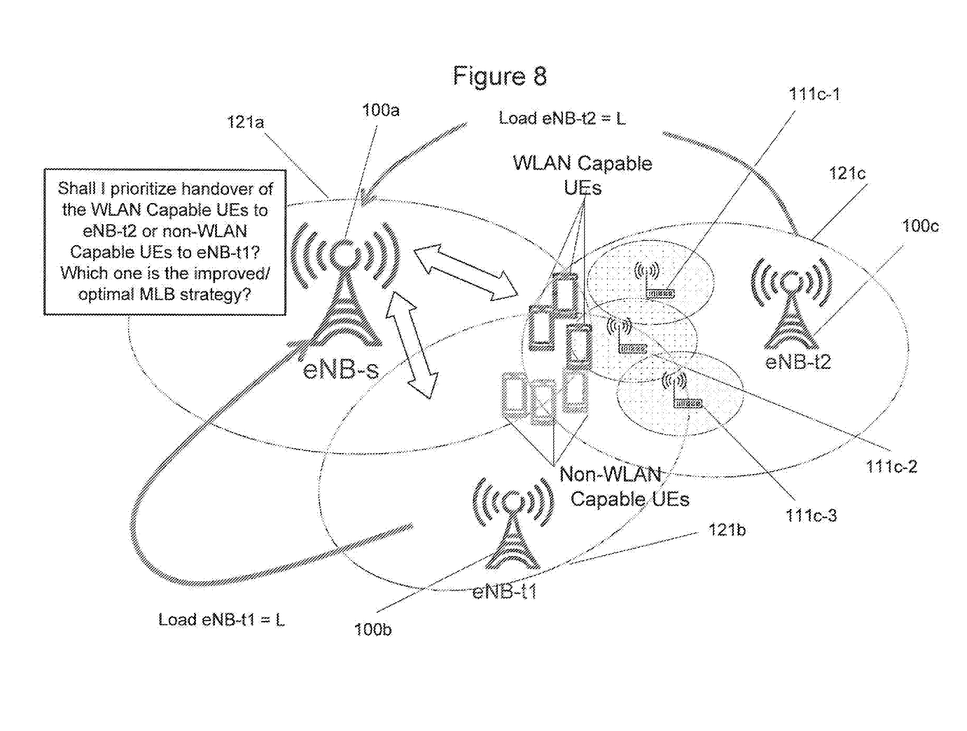

As discussed below with respect to FIGS. 8, 9, and 10, for example, base stations 100a, 100b, and 100c may be neighbor base stations with overlapping border regions of coverage areas or cells 121a, 121b, and 121c. By way of example, base station 100a may be discussed as a source base station (eNB-s) that is offloading (handing over) wireless terminals responsive to an overload condition (e.g., a load communications traffic exceeds a load threshold), and base stations 100b and 100c may be discussed as target base stations (eNB-t) to which wireless terminals are offloaded from base station 100a. A same base station, however, may be a source base station at one time and a target base station at another time.

While WLAN access points are illustrated in each coverage area or cell, WLAN access points may not be provided in all of the macro coverage areas or cells 121a, 121b, and 121c. A plurality of WLAN APs is illustrated in each macro coverage area or cell only by way of example. In FIG. 21, each of WLAN APs 111a-1 to 111a-x, 111b-1 to 111b-y, and 111c-1 to 111c-z may be operator-controlled WLAN APs such that control of these WLAN APs is integrated with the cellular radio access network including base stations 100a, 100b, and 100c to provide a same service(s) across the base stations and operator controlled WLAN APs.

As discussed in greater detail below, base stations 100a, 100b, and 100c may exchange information regarding WLAN APs in the different coverage areas or cells 121a, 121b, and/or 121c to allow more efficient decisions regarding hand over and/or offloading, for example, in an overload condition.

While a backhaul coupling is provided between each WLAN AP and a respective base station processor 101, such couplings are not required for some or all WLAN APs. A base station processor 101, for example, may receive information regarding WLAN APs within a macro coverage area or cell of the base station based on wireless terminal reporting (e.g., received through transceiver 103a). Upon receipt of such information regarding WLAN APs within its coverage area or cell (e.g., through a backhaul coupling and/or through wireless terminal reporting), the base station processor may save the information in memory. Moreover, information regarding WLAN APs may be transmitted between base station processors over the X2 interface(s) and stored in respective memories. Accordingly, each base station memory 105 may include information regarding WLAN APs in its own coverage area or cell and in coverage areas or cells of neighboring base stations. A base station processor may thus make decisions regarding wireless terminal hand over based on information regarding WLAN APs operating in coverage areas or cells of neighboring base stations.

WLAN and 3GPP Integration

In IEEE, Wi-Fi (also known as WLAN and these terms will be used interchangeably throughout this document) is standardized in the 802.11 specifications (IEEE Standard for Information technology—Telecommunications and information exchange between systems. Local and metropolitan area networks—Specific requirements. Part 11: Wireless LAN Medium Access Control (MAC) and Physical Layer (PHY) Specifications). Wi-Fi is a technology that currently operates primarily on the 2.4 GHz band and/or the 5 GHz band. The IEEE 802.11 specifications regulate the STA (access points or wireless terminals) physical layer, MAC layer and other aspects to secure compatibility and inter-operability between access points and wireless/portable terminals, (referred to as UE's). Wi-Fi is generally operated in unlicensed bands, and as such, communication over Wi-Fi may be subject to interference sources from any number of both known and unknown devices. Wi-Fi is commonly used as a wireless extension to fixed broadband access (e.g., in domestic environments and hotspots, like airports, train stations and restaurants).

Recently, Wi-Fi has been subject to increased interest from cellular network operators, in addition to use as an extension to fixed broadband access. For cellular network operators, the Wi-Fi technology may be used as an extension, or alternative, to cellular radio access network technologies to handle always increasing wireless bandwidth demands. Cellular operators that are currently serving mobile users with cellular radio access technologies (e.g., any of the 3GPP technologies, LTE, UMTS/WCDMA, or GSM) may see Wi-Fi as a wireless technology that can provide good support in their regular cellular networks. The term “operator-controlled Wi-Fi” (also referred to as operator controlled WLAN) indicates a Wi-Fi deployment that on some level is integrated with a cellular network operator's existing network where the 3GPP radio access networks and the Wi-Fi wireless access may even be connected to the same core network and provide the same services.

There is currently activity in the area of operator-controlled Wi-Fi in several standardization organizations. In 3GPP, activities to connect Wi-Fi access points to the 3GPP-specified core network are being pursued, and in the Wi-Fi alliance (WFA) activities related to certification of Wi-Fi products are being undertaken, which to some extent may also be driven from a need to make Wi-Fi a viable wireless technology for cellular operators to support high bandwidth offerings in their networks. The term Wi-Fi offload is commonly used and points towards cellular network operators seeking means to offload traffic from their cellular networks to Wi-Fi (e.g., in peak-traffic-hours and/or in situations when the cellular network for one reason or another needs to be off-loaded, for example, to provide requested quality of service, increase/maximize bandwidth and/or simply for coverage).

For a wireless operator, when offering a mix of two technologies that are standardized in isolation from each other, a challenge may be to provide intelligent mechanisms that interact with both technologies, such as connection management.

Most current WiFi deployments are totally separate from mobile networks, and are to be seen as non-integrated. From the UE perspective, mobile operating systems may support a simple connection management mechanism, where the UEs immediately switch all their PS (Packet Switched) bearers to a WiFi network upon a detection of such a network with a certain signal level. The decision to offload to a WiFi node or not is referred henceforth as the access selection strategy and the aforementioned strategy of selecting WiFi whenever such a network is detected is known as “WiFi-if-coverage”. While this may be a good strategy (e.g., for Wi-Fi deployed as extensions of a residential broadband connection to a fixed line operator), for mobile network operators that aim to integrate Wi-Fi as a component in their wireless networks, more may be desired.

In 3GPP, there have long been activities on an Access Network Discovery and Selection Function, referred to as ANDSF. ANDSF provides policies to the UE from an ANDSF server (typically set by the operator of the currently visited or home network). These policies indicate priorities that the UE should follow when selecting an access network. For example, a policy could include information that in a certain area at a certain point in time, WLAN/Wi-Fi is preferred over a 3GPP access. With an ANDSF server, the operator can thus distribute policies to UE's to steer access selection.

ANDSF is further described, for example, in, 3GPP TS 23.402 v12.1.0, Architecture enhancements for non-3GPP accesses and TS 24.312v12.1.0, Access Network Discovery and Selection Function (ANDSF) Management Object (MO).

As previously stated, selecting a Wi-Fi access point has always been executed in the UE. ANDSF does not change this, but adds a possibility to indicate a policy or preference of access selection or RAN selection based, for example, on a geographical, chronological, service or subscriber perspective. It is up to the UE to interpret and act on the policies and select an access network in either, e.g., 3GPP, WLAN, WiMAX, CDMA, etc. In 3GPP TS 24.312, all the different elements that are possible to indicate are listed. It should be noted that if a user is manually adding preferences (e.g., adding a home access point extending a fixed broadband connection or similar as a preferred access point) then this is expected to override any other access network selection procedure, be it ANDSF rules, algorithms in the UE's operating system or connection manager or network controlled selection schemes.

One challenge with the ANDSF solution is that it is not specified to have any connection to any Radio Access Network (RAN). Thus, ANDSF has no support in standard for conveniently following, for example, dynamic changes of radio conditions in the RAN. It would be good if decisions about traffic steering of a UE to either 3GPP or Wi-Fi could be based on more instantaneous and dynamic information about radio conditions, such that users are not unnecessarily sent to a congested access point or access technology.

Another issue that has been identified with ANDSF is that since it leaves the execution of the policies to the UE, it is not predictable (from a radio network perspective) how a UE will move between access networks, making it more difficult to optimize radio network performance.

To address these and other shortcomings with the ANDSF solution, a radio access network (RAN) controlled traffic steering is currently being discussed in 3GPP in relation to a study item called WLAN/3GPP Interworking, described in 3GPP TR 37.834v0.3.0 Study on WLAN/3GPP Radio Interworking (Release 12) and in study item description RP-122038 in 3GPP. RP-122038 states that one of the objectives with a new solution is that it should be able to take dynamically changing conditions like radio access network load and performance into account. One of the solution proposals discussed is a RAN controlled approach. With a RAN (Radio Access Network) controlled access selection, it is the network (and not the UE) that takes the decision on what access link to use for communication to or from a UE. The RAN control of traffic steering should be able to capture the dynamics in varying radio conditions as well as provide predictability to be better able to optimize radio access network performance as well as user performance.

Below, two alternatives to perform traffic steering between the two WLAN and 3GPP are presented.

A first alternative may be based on conditions and thresholds provided to the terminal by 3GPP which dictates in which situations the terminal should steer traffic from/to a WLAN. This alternative may be applicable whether or not a connection exists between the terminal and 3GPP RAN (e.g. both when a terminal is in RRC_CONNECTED mode in 3GPP LTE and when the terminal is in IDLE mode in LTE).

The second alternative allows the 3GPP RAN to control a wireless terminal's connection to WLAN by sending traffic steering commands ordering the wireless terminal to steer traffic from/to the WLAN. To send the traffic steering command, a connection may be established between the wireless terminal and the 3GPP RAT (radio access technology), e.g. for a terminal to be in RRC_CONNECTED mode in 3GPP LTE if LTE should be in sending traffic steering commands.

It may be possible that both of these alternatives are used where the first (threshold based) alternative is used when no connection exists between the UE and the 3GPP RAN and the second (traffic steering command) alternative is used when a connection exists.

Threshold Based Approach

In this alternative for performing traffic steering between 3GPP and WLAN, the 3GPP network provides the UE with conditions and thresholds which dictate in which situations the wireless terminal should steer traffic from one RAN to the other. For example, the set of conditions and thresholds could include: If the RSRP of current serving 3GPP cell is below threshold_RSRP, and there exists a WLAN with a RSSI_WLAN>RSSI_threshold and this WLAN is advertising a load level below WLAN₋load_threshold, then offload traffic to WLAN (or for the case when the UE was in IDLE mode, use WLAN when sending first UL data).

Traffic Steering Command Based Approach Another alternative to perform traffic steering between 3GPP and WLAN is based on measurement reporting from the terminal and traffic steering commands sent to the terminal from the 3GPP RAN. FIG. 6 illustrates signaling interactions for connected mode 3GPP/WLAN interworking as discussed below.

Step 6-1 of FIG. 6:

The 3GPP RAN (e.g., base station 100) provides the UE with a set of conditions and thresholds and the UE should then start to scan for and measure WLAN signals. This step may occur before there is WLAN coverage (e.g., when load-balancing may be considered). This step may reduce battery consumption of the UE as it can avoid unnecessary scanning and measurements on the WLAN . The conditions and thresholds could, for example, be that RSSI (received signal strength indicator) of WLAN should be above X dBm, 3GPP RSRP (reference signal received power) should be below Y dBm and/or BSS (basic service set) load (as advertised by WLAN) should be below Z.

RSSI>X

RSRP<Y

BSS load<Z

Step 6-2 of FIG. 6:

If the conditions specified in step 1 are met, the UE should send a measurement report containing the results of the discovery of Access Points (APs). This is represented by step 6-2 of FIG. 6. The 3GPP RAN (e.g., base station 100) will then evaluate the reported results from the UE, considering also any other reports and information the network may have available, such as backhaul congestion, delay, subscription information and interference, and determine whether or not to steer the UE's traffic to WLAN.

Step 6-3 of FIG. 6:

If the 3GPP RAN (e.g., base station 100) decides it is suitable that the traffic of a particular UE should be re-directed to WLAN then step 6-3 is executed. The re-direction may contain a specific target, such as a prioritized AP/WLAN network or it could be just a command telling the UE to steer its traffic to WLAN and the UE and WLAN will decide to which particular AP the UE would use. The third step is the actual traffic steering command sent from the 3GPP RAN to the UE. It contains information so that the UE can initiate traffic steering according to mechanisms developed or to be developed in CT (Core Network and Terminals) and SA (System Architecture) groups.

A given source eNB, however, may not know the existence of WLAN APs or any other access nodes of another technology within the coverage area of its neighboring eNBs. Thus, the source eNB cannot utilize such information to improve/optimize MLB procedures even further.

Descriptions of problems, scenarios and/or solutions herein may refer to particular embodiments, e.g., mobility load balancing between LTE cells. This disclosure does not, however, restrict use of principles behind these embodiments to other embodiments involving different source or target RATs.

Embodiments of inventive concepts may include enhancements to reporting procedures where a first node (e.g., base station 100a) of a given technology may send a REQUEST_MESSAGE to a second node (e.g., base station 100b) of the same technology (e.g., LTE) about a third node (e.g., WLAN AP 111b-1) or set of nodes (e.g.,. WLAN APs 111b-1 to 111b-y) of a different technology (e.g., WiFi). The second node (e.g., base station 100b) and the third node(s) (e.g., WLAN AP 111b-1 or WLAN APs 111b-1 to 111b-y) may have a common interface (e.g., a backhaul) through which the third node(s) can send control information to the second node, for example, load and/or measurement reports. The second node may control the third node(s) of the other technology as shown in FIG. 7. In this example, technology A could be a 3GPP technology (e.g., UTRAN or E-UTRAN and technology B could be WLAN). FIG. 7 illustrates nodes, technologies, and messages according to some embodiments of inventive concepts.

An IE/Group Name of the REQUEST_MESSAGE may be enhanced by including additional bits representing the request from the first node (e.g., base station 100a) to the second node (e.g., base station 100b) about the following information:
of load measures of associated nodes of different technologies. The second node may respond to the first node with a RESPONSE_MESSAGE which acknowledges the first node that the requested measurements indicated by the REQUEST_MESSAGE are successfully initiated.

The second node may send updates about the requested reports in an UPDATE_MESSAGE. Alternatively, the second node may send a failure or cancelation message to the first node, indicating that some or all of the measurements required are not available.

In a second embodiment, a second node is associated with one or multiple sets of nodes from one or multiple different technologies. The association between the second node and each set of nodes could be an overlapping coverage area. The second node may have a control and/or management interface to the set of nodes from the multiple technologies where control information can be exchanged.

It should be noted that though all the following embodiments of inventive concepts use WLAN as an example, inventive concepts described therein may also be applicable to 3GPP technologies and/or to any other non-3GPP technology as well. For example, a UMTS (Universal Mobile Telecommunications System) cell may have several LTE pico cells in its coverage area, and similar to the LTE-WLAN case, it may be beneficial to consider the number/load/capability of the LTE pico cells between two neighboring UMTS base stations when performing load balancing.

### EXAMPLES

Knowledge of existence of WLAN APs under the coverage of neighbor cells

In the example of FIG. 8, each base station eNB has only one cell, the target base stations eNB-t1 and eNB-t2 (e.g., base stations 100b and 100c) shown in FIG. 8 report similar load values to a requesting source base station eNB-s (e.g., base station 100a), eNB-t2 (e.g., base station 100c) has a certain number of AP's (e.g., WLAN APs 111c-1, 111c-2, and 111c-3) within its coverage area 121c, and there are no APs inside eNB-t1 coverage area 121b. In this case, the source base station eNB-s (e.g., base station 100a) can prioritize the WLAN capable UEs to be handed over to target base station eNB-t2 (e.g., base station 100c).

Knowledge of the Capabilities of WLAN APs Under the Coverage of Neighbor Cells

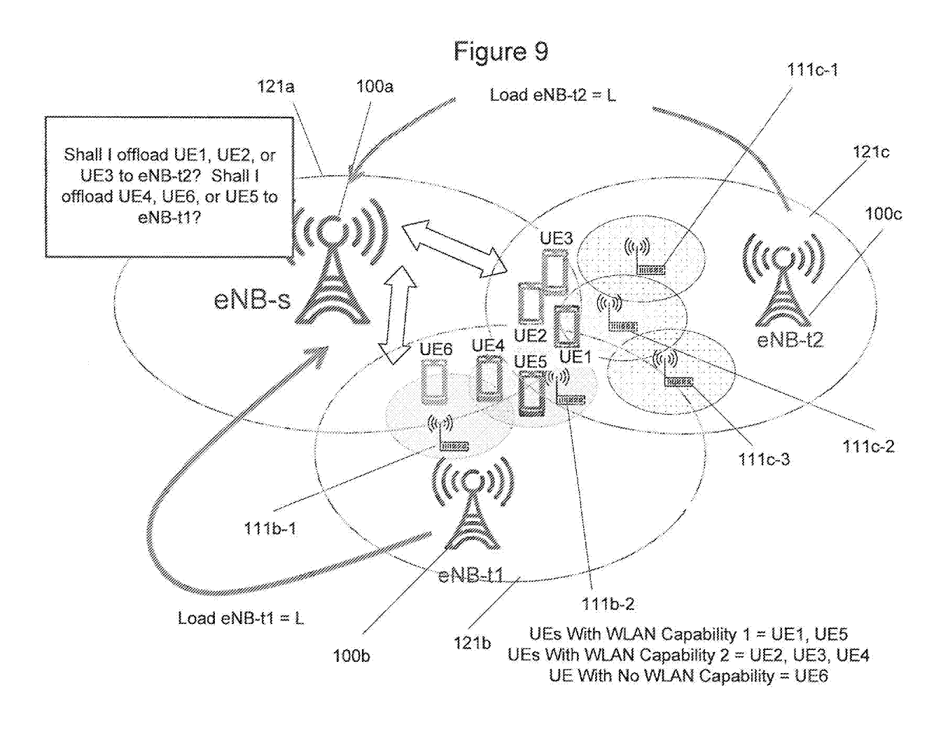

In the example of FIG. 9, each base station eNB has only one cell, the target base stations eNB-t1 and eNB-t2 (e.g., base stations 100b and 100c) report similar load values to a requesting source base station eNB-s (e.g., base station 100a), and both target base stations eNB-t1 and eNB-t2 have a certain number of AP's (e.g., WLAN Access Points 111b-1, 111b-2, 111c-1, 111c-2, and 111c-3) within their respective coverage areas 121b and 121c. However, these AP's have different capabilities (e.g. operation frequency, band, QoS support, etc.).

In the context of UE grouping based MLB, the source base station eNB-s (e.g., base station 100a) can select specific groups of users (wireless terminals or UEs) to be handed over. These groups may be defined based on their WLAN capabilities and handed over accordingly based on the WLAN capabilities of the AP's covered by the target base stations eNB-t1 and eNB-t2.

Knowledge of the Load of WLAN APs Under the Coverage of Neighbor Cells

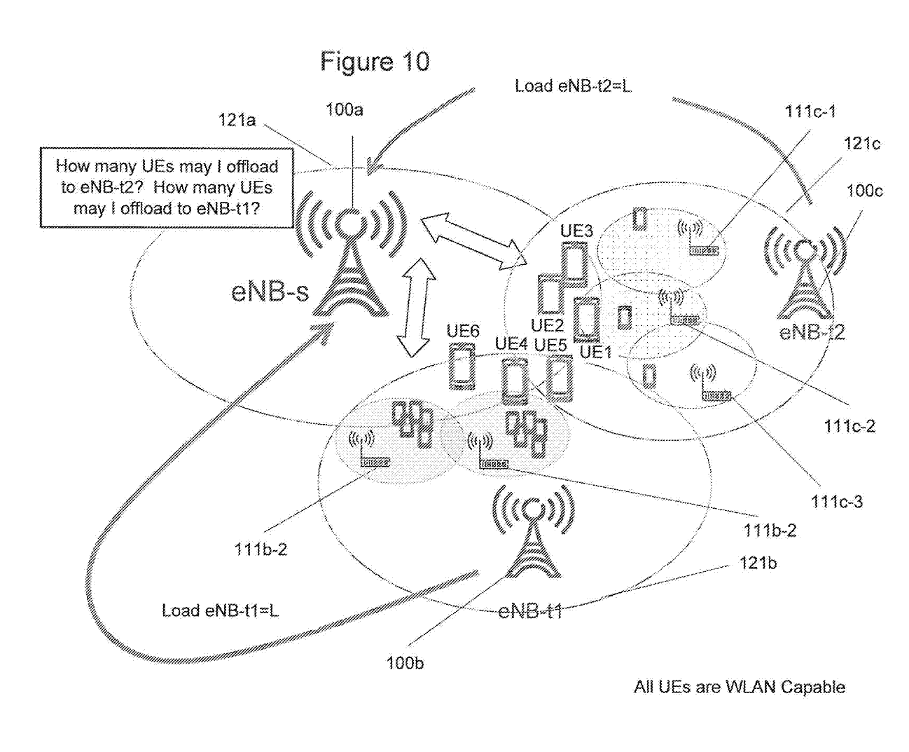

In the example of FIG. 10, each base station eNB may have only one cell, the target base stations eNB-t1 and eNB-t2 (e.g., base stations 100b and 100c) shown in FIG. 10 report similar load values to a requesting source base station eNB-s (e.g., base station 100a), and both target base stations eNB-t1 and eNB-t2 have a certain number of AP's (e.g., WLAN APs 111b-1, 111b-2, 111c-1, 111c-2, and 111c-3) within their coverage areas. However, the APs (e.g., WLAN APs 111b-1 and 111b-2) under the coverage of target base station eNB-t1 (e.g., base station 100b) are more loaded than the APs (e.g., WLAN APs 111c-1, 111c-2, and 111c-3) under the coverage of target base station eNB-t2. If source base station eNB-s (e.g., base station 100a) is aware of these load situations, source base station eNB-s can prioritize the handover of WLAN capable UEs towards eNB-t2 (e.g., base station 100c).

X2 Setup Request/Response and eNB Configuration Update Enhancements

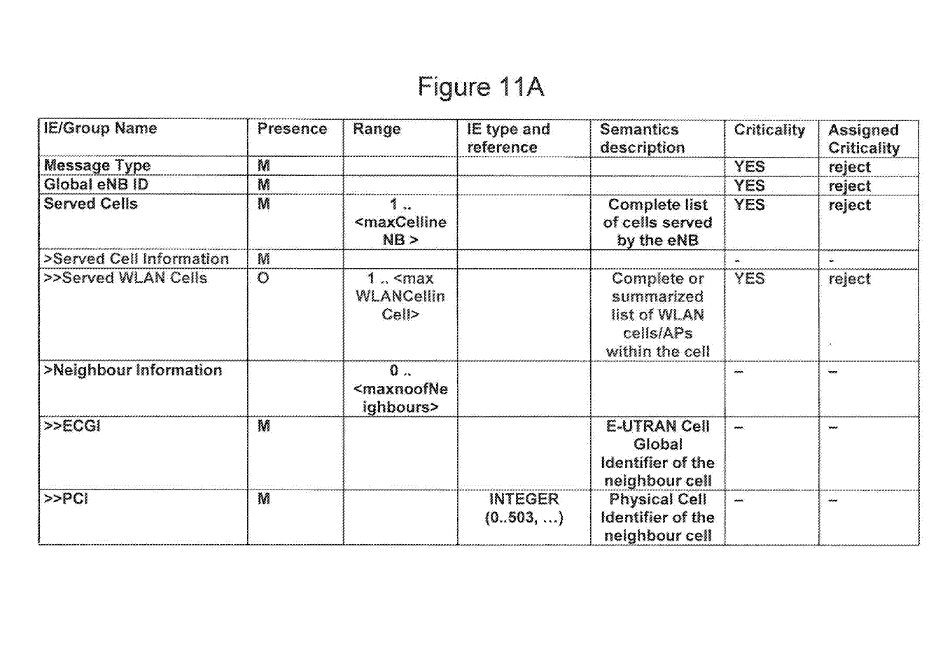

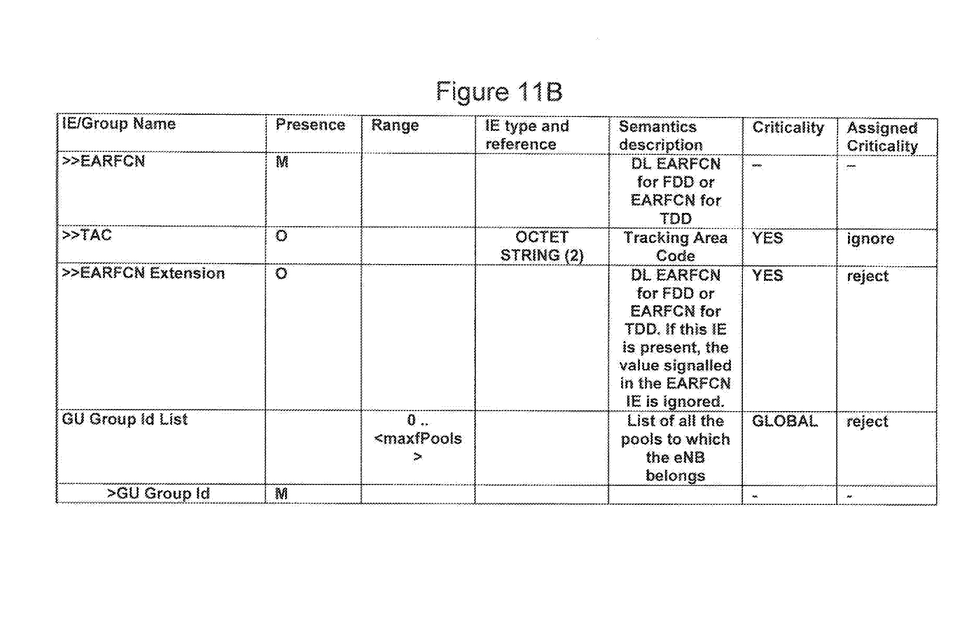

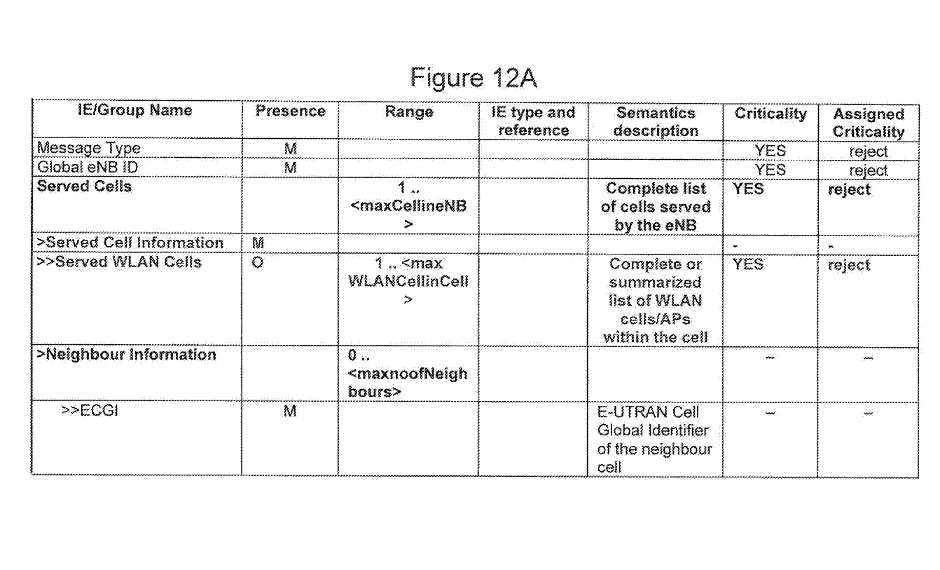

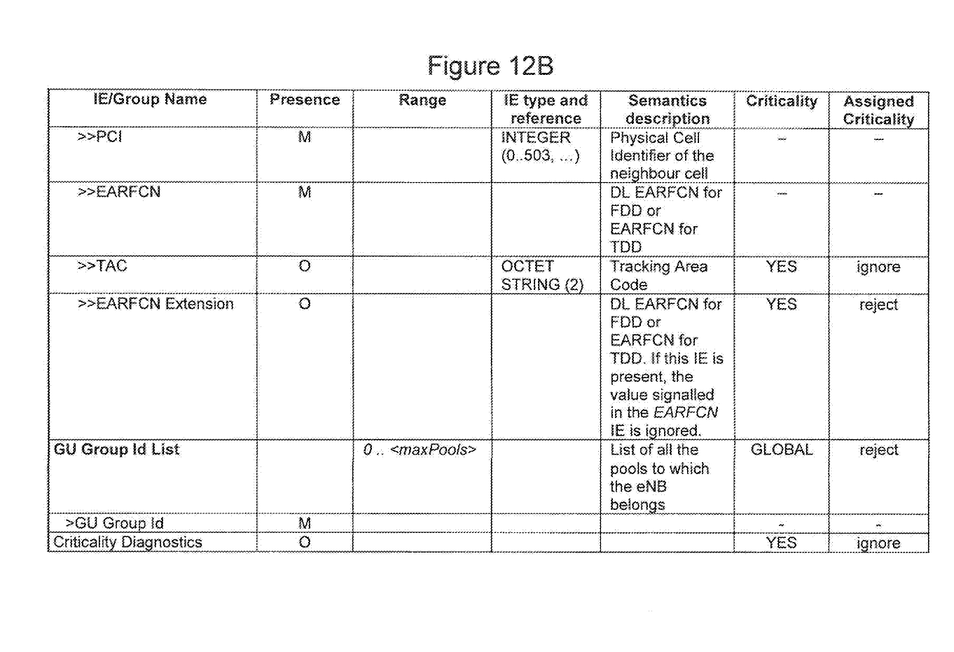

Neighboring base stations eNBs (e.g., base stations 100a, 100b, and 100c) can communicate summarized and/or detailed information of the small/pico cells of other technology (e.g., WiFi/WLAN cells/APs) within their respective coverage areas using an extension of the X2 SETUP REQUEST/RESPONSE messages as well as the eNB CONFIGURATION UPDATE messages. A Served WLAN Cells IE (Information Element) can be added to the X2 SETUP REQUEST/RESPONSE messages, and an example is illustrated in FIGS. 11A, 11B, 12A, and 12B, where the new information elements (IE) include: “>Served Cell Information”, and “>>Served WLAN Cells”.

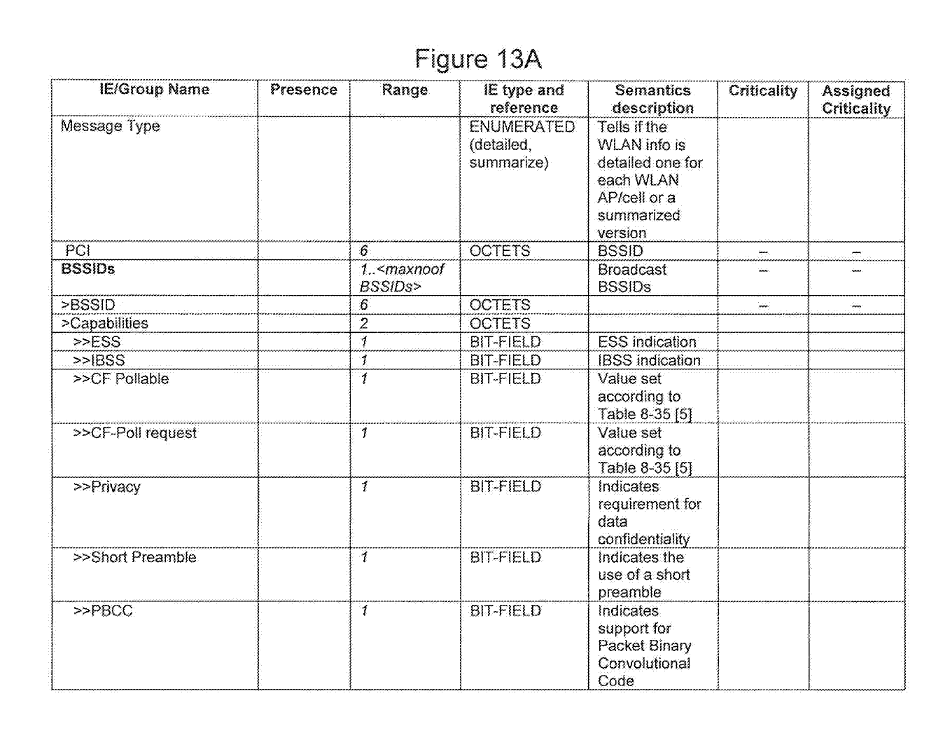

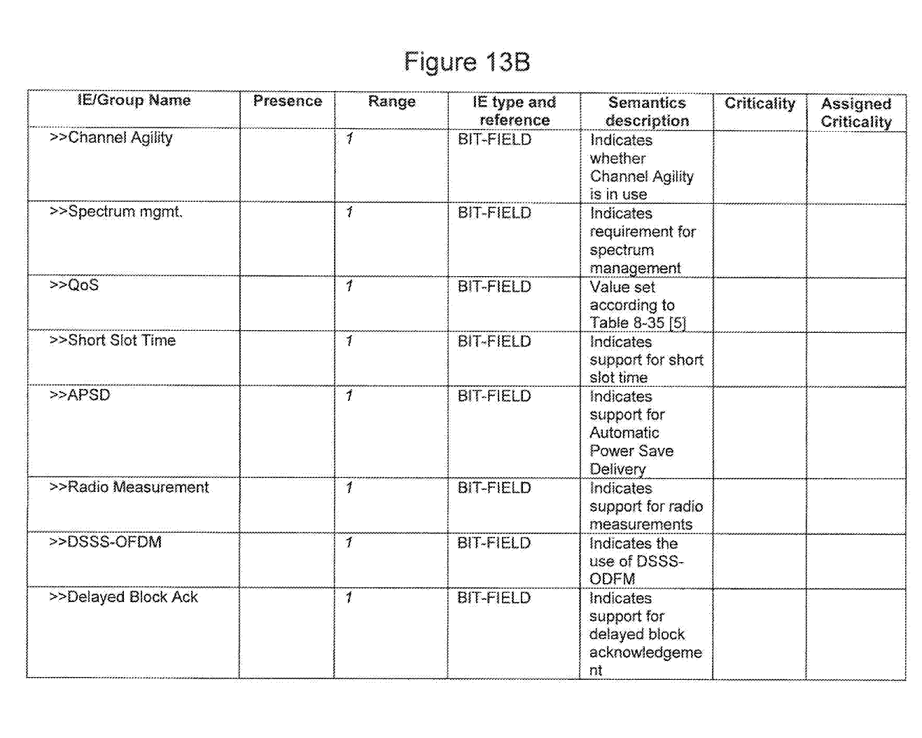

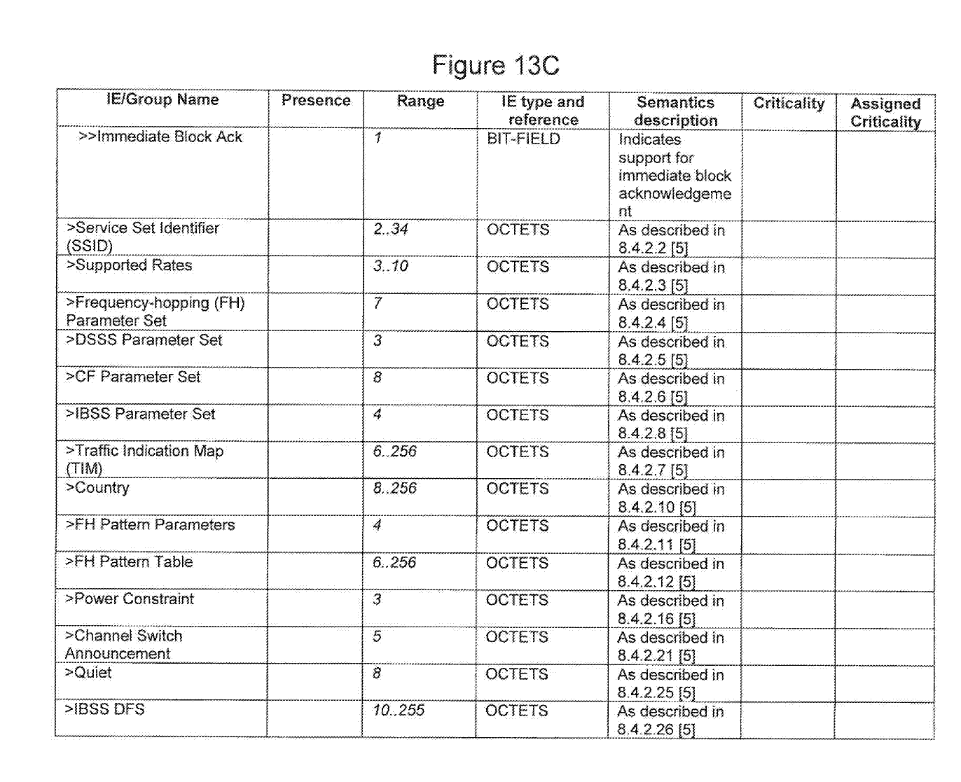

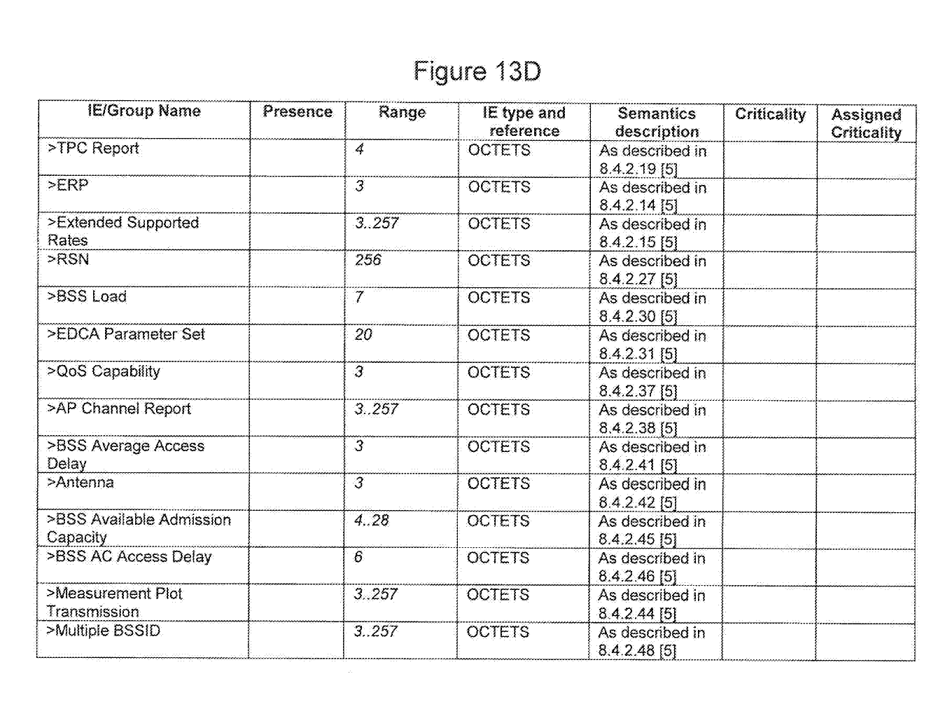

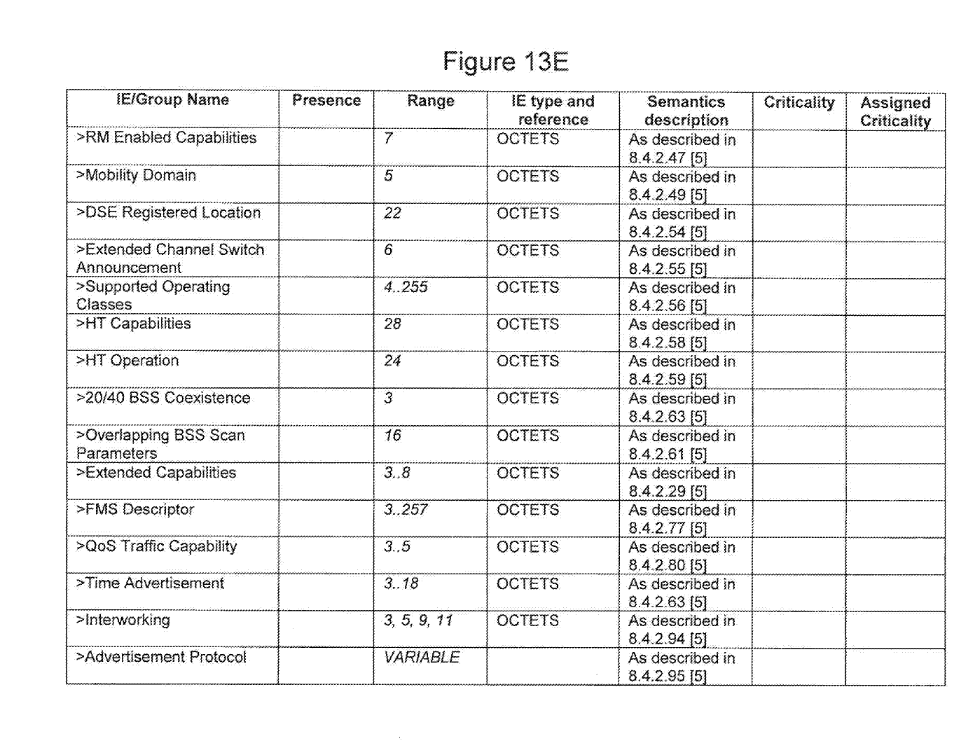

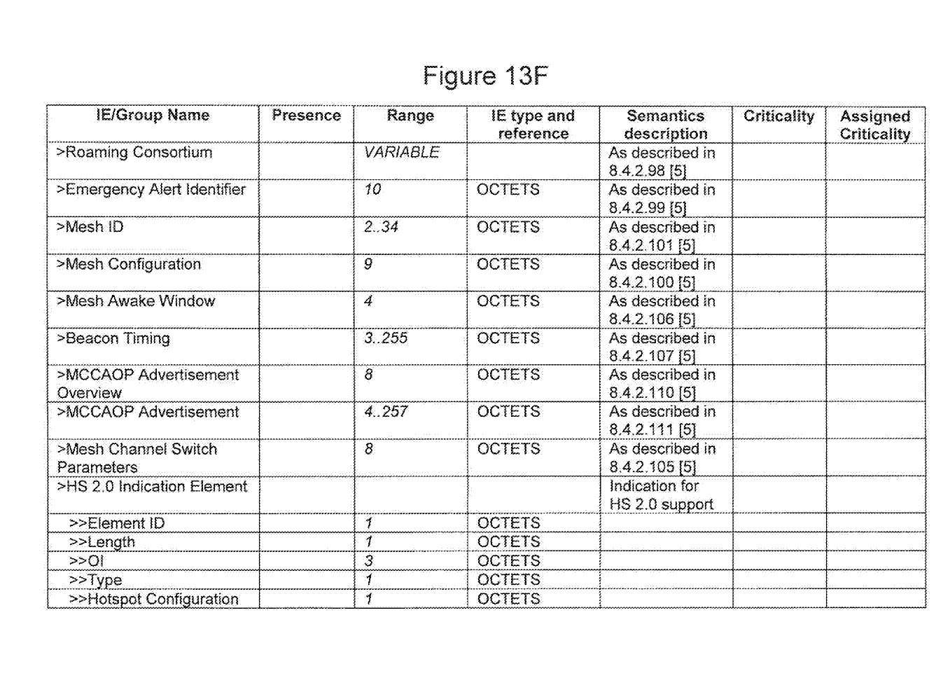

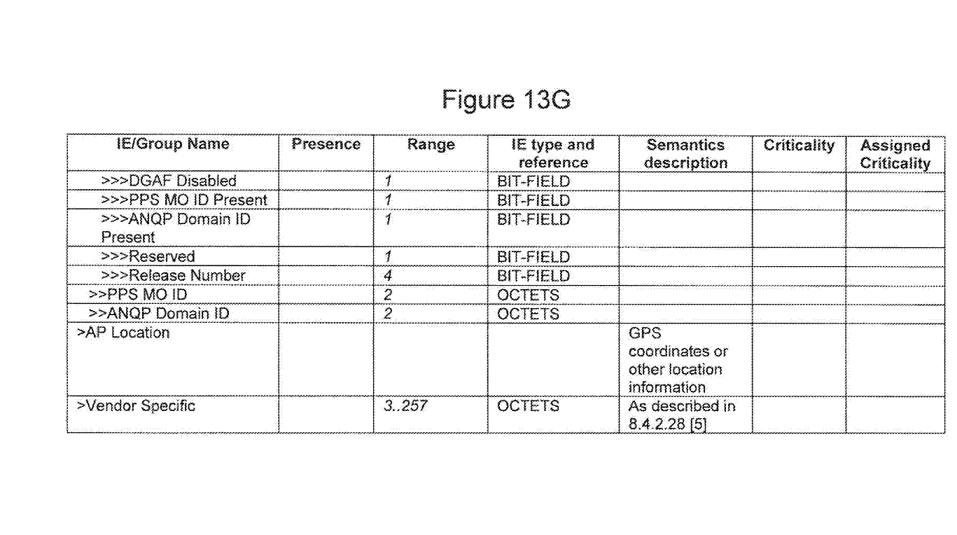

FIGS. 11A and 11B provide a table illustrating an example of an Enhanced X2 SETUP REQUEST used to communicate WLAN information. FIGS. 12A and 12B provide a table illustrating an example of an Enhanced X2 SETUP RESPONSE used to communicate WLAN information. FIGS. 13A, 13B, 13C, 13D, 13E, 13F, and 13G provide a table illustrating an example of detailed information of a “>>Served WLAN cell” IE.

The table of FIGS. 13A, 13B, 13C, 13D, 13E, 13F, and 13G is an example and may include many/most of the currently available WLAN capabilities for the sake of completeness. Only a subset of the capabilities, however, may be relevant to some embodiments of inventive concepts. Some of the more notable parameters of FIGS. 13A, 13, 13C, 13D, 13E, 13F, and 13G include:
ESSID—the Extended Service Set IDentifier of which the WLAN AP is part. The ESS comprises of one or multiple interconnected Basic Service Sets or BSSs (WLAN AP), which appear as one logical entity to any station STA (wireless terminal) connected to any of the underlying BSSs;
AP Location—GPS coordinates or other location information related to the position of the WLAN AP;
Operating frequency (channel number)—indicates the frequency at which the AP operates (by either explicitly signaling the frequency or pointing to a channel number as defined in “Part 11: Wireless LAN Medium Access Control (MAC) and Physical Layer (PHY) Specifications”, IEEE Std. 802.11-2012, IEEE Computer Society). Note that a single AP can operate on several frequencies/channels simultaneously;
BSS Load—contains information on the current STA population and traffic levels in the WLAN AP;
HS 2.0 Indication Element—provides Hotspot 2.0 related information (HS 2.0 revision compliance, etc.).

It should also be noted that the information of FIGS. 13A, 13B, 13C, 13D, 13E, 13F, and 13G can also be communicated in a summarized fashion. For example, instead of providing the detailed information of every AP, the provided information could be in the form of “There are x APs that support these capabilities”.

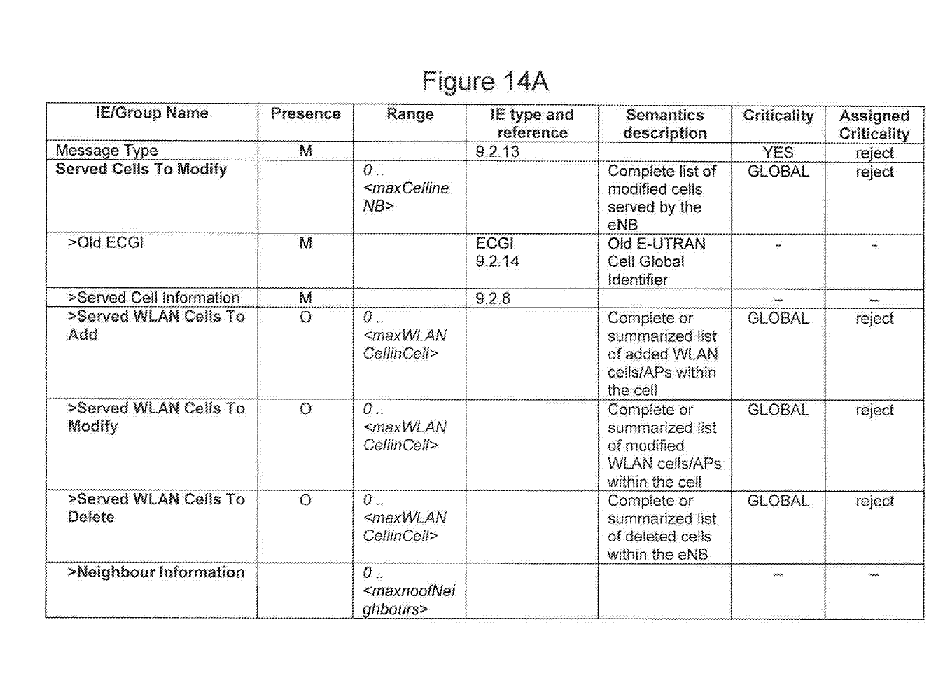

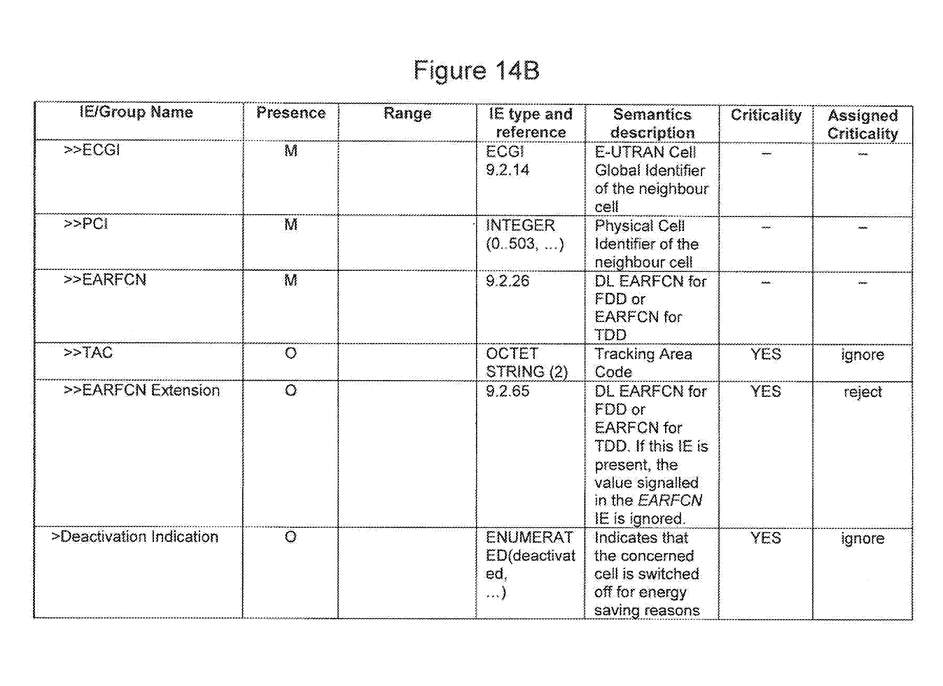

FIGS. 14A and 14B provide a table illustrating an example of an eNB configuration update message used to communicate additions/modification/deletion of WLAN cells/AP within eNB cells (e.g., including additional information elements “>served WLAN cells to add”, “>served WLAN cells to modify”, and “>served WLAN cells to delete”). Note that in the example of FIGS. 14A and 14B, the “served cells to modify” part of the eNB configuration update message is used to communicate the information about the addition/modification/deletion of WLAN APs/Cells, and the other parts are not shown.

Similar to the X2 Setup/Response cases, either detailed or summarized information can be communicated in the eNB configuration update.

Enhancements to X2 Resource Status Reporting/Initiation

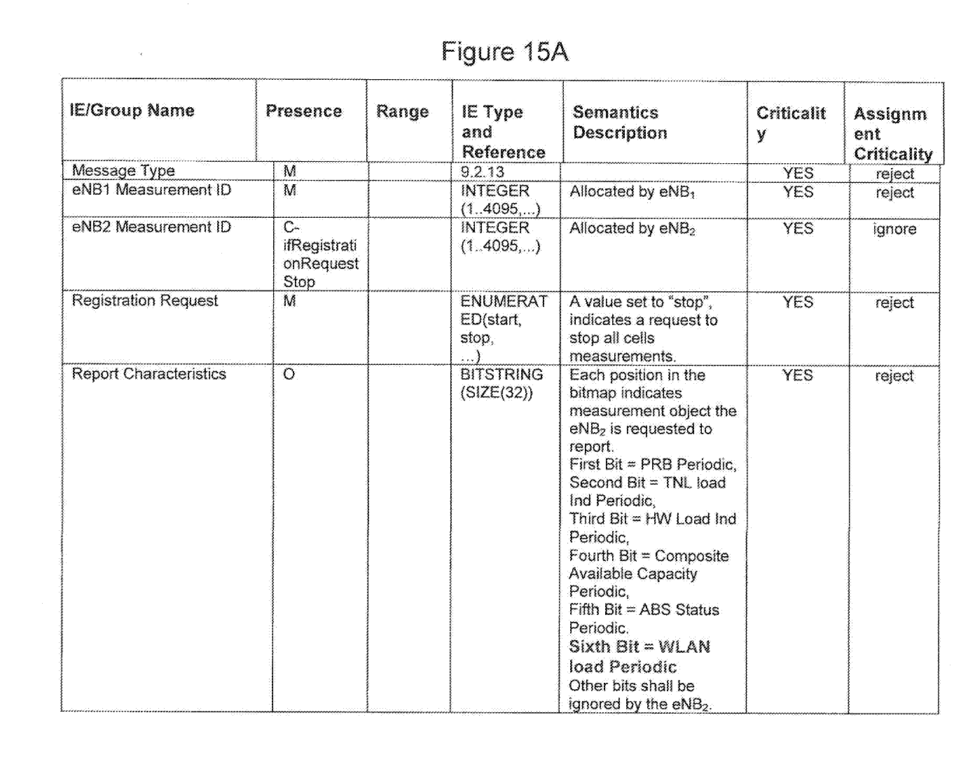

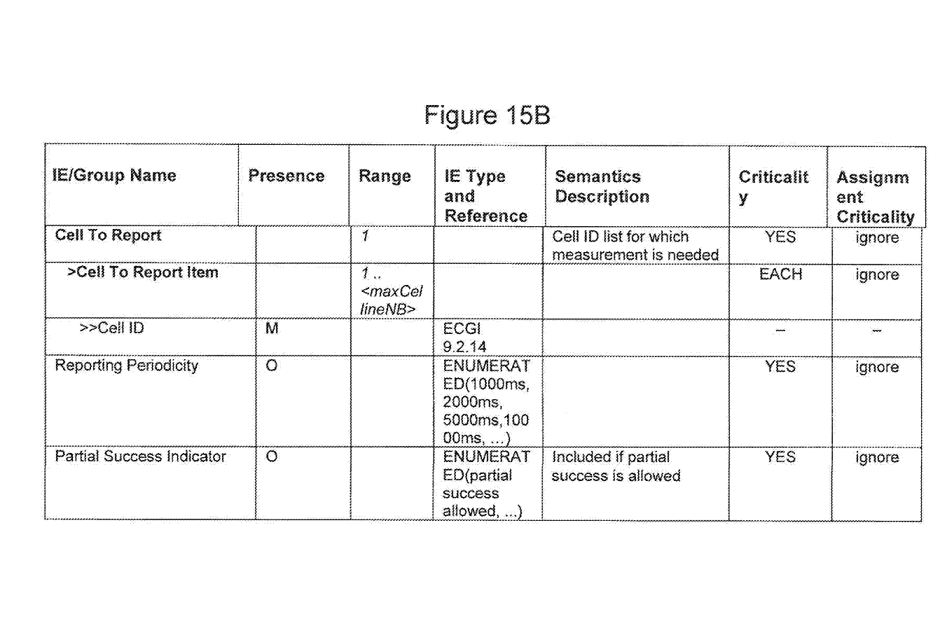

The first (source) and second (target) nodes (e.g., base stations 100a and 100b) may be eNBs and the third node (e.g., WLAN AP 111b-1, 111b-2, and/or 111b-3) may be a WLAN AP (access point). The reporting procedure may be the RESOURCE STATUS REPORTING/INITIATION that is exchanged using the X2 interface between the eNBs. The REQUEST_MESSAGE may be the RESOURCE STATUS REQUEST and the IE called “Report characteristics” may be enhanced as illustrated in FIGS. 15A and 15B to include “Sixth Bit=WLAN load periodic”. FIGS. 15A and 15B provide a table illustrating an example of a Modified Resource status request message used to request reporting of inter RAT load.

The modified IE above can also be sent over a direct interface connecting the sending node (base station) with the node (access point or AP) of different technology for which the load reporting is requested.

In the example of FIGS. 15A and 15B with the modified IE for the resource status request, it has been assumed that if a cell is included in the list, the request also is for all the WLAN APs/cells within that cell. However, such detailed information may not be relevant and/or necessary for the requesting eNB/cell (e.g., most of the APs in cell A of eNB2 may be near the border of cell X of eNB3). Thus, the requester can specify which particular APs or which type of APs (e.g. with a given capability) that it is interested in receiving load information about.

A single load reporting periodicity may be specified in the “Reporting Frequency” IE of the legacy resource status request message, which means every reporting period the load information of every cell included in the request will be reported. However, in the present example, where there can be a relatively large number of WLAN APs, reporting all the information about every AP may result in unnecessary signaling overhead. As such, a different reporting periodicity can be specified for the WLAN APs/cells as compared to the LTE cells. One can even envision having different reporting periodicity for WLAN APs of different capability (for example, report the load of LTE cells every x seconds, load of WLAN APs with capability A every x1 seconds, load of WLAN APs with capability B every x2 seconds, etc.).

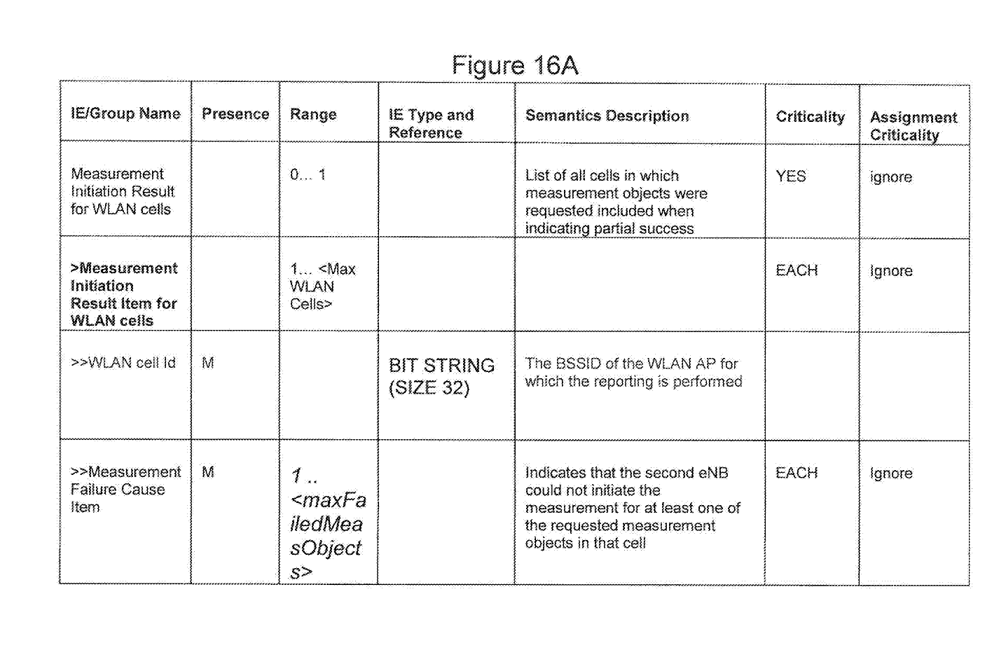

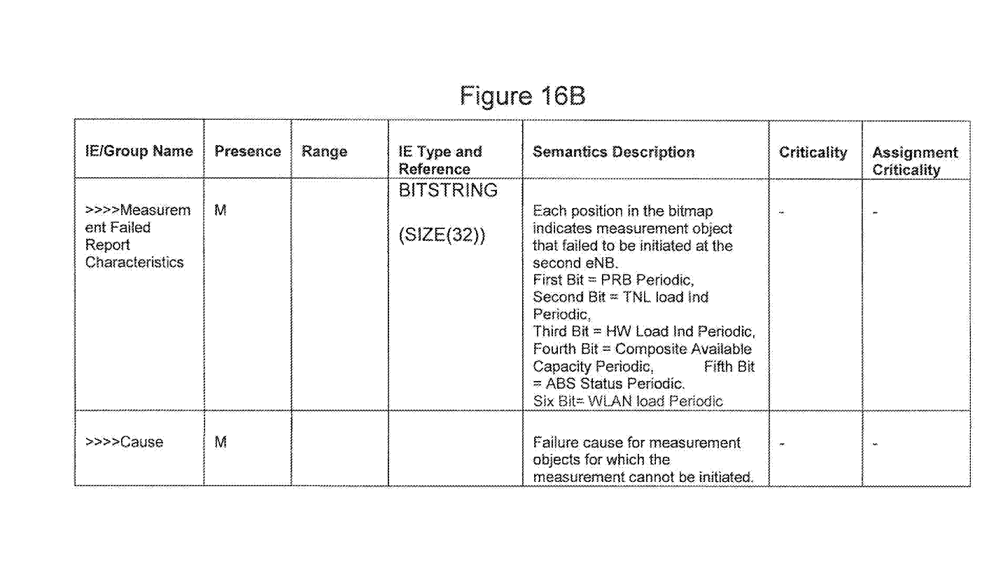

An example of the parts of an enhanced RESOURCE STATUS RESPONSE message in response to the RESOURCE request message shown above is illustrated in FIGS. 16A and 16B which illustrates new IEs in the RESPONSE MESSAGE for reporting of non-3GPP system load.

Moreover, the RESPONSE MESSAGE enhanced as in the table of FIGS. 16A and 16B may be sent directly from a node supporting a different technology (for example, a WLAN AP) to the first node, for example an eNB. In this, case an interface connecting the two nodes should be available.

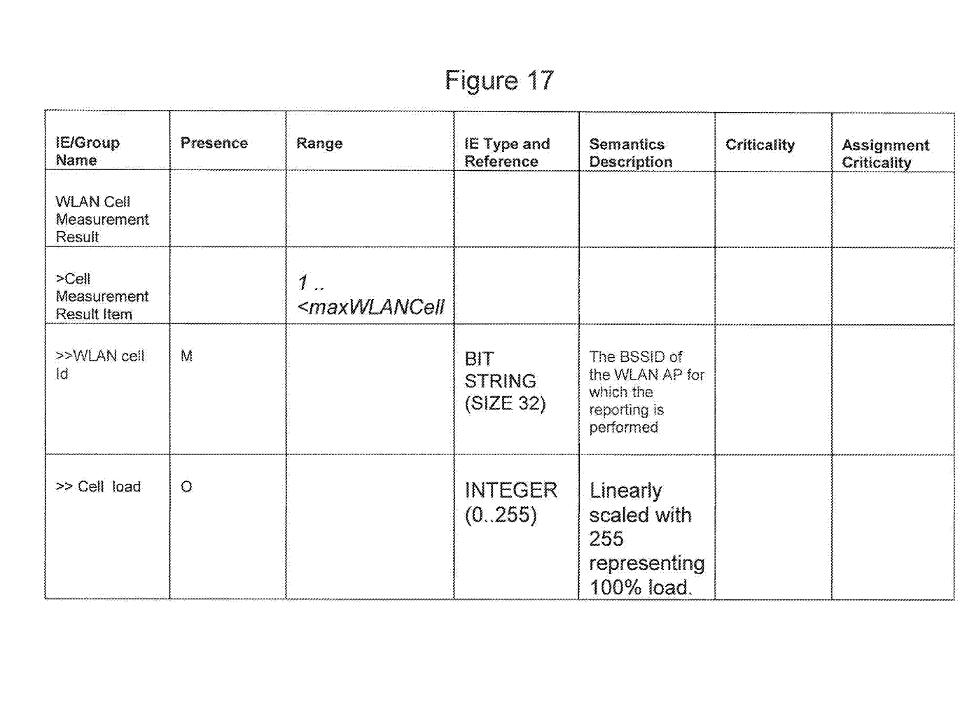

In the case where updates of the inter RAT load reporting need to be provided (e.g., when the reporting periodicity time has elapsed), an UPDATE MESSAGE can be used with the IEs of FIG. 17 to report WLAN load. For example, in the case of E-UTRAN, the message RESOURCE STATUS UPDATE may be enhanced with the IEs of FIG. 17 (including the information element “>>WLAN cell ID”).

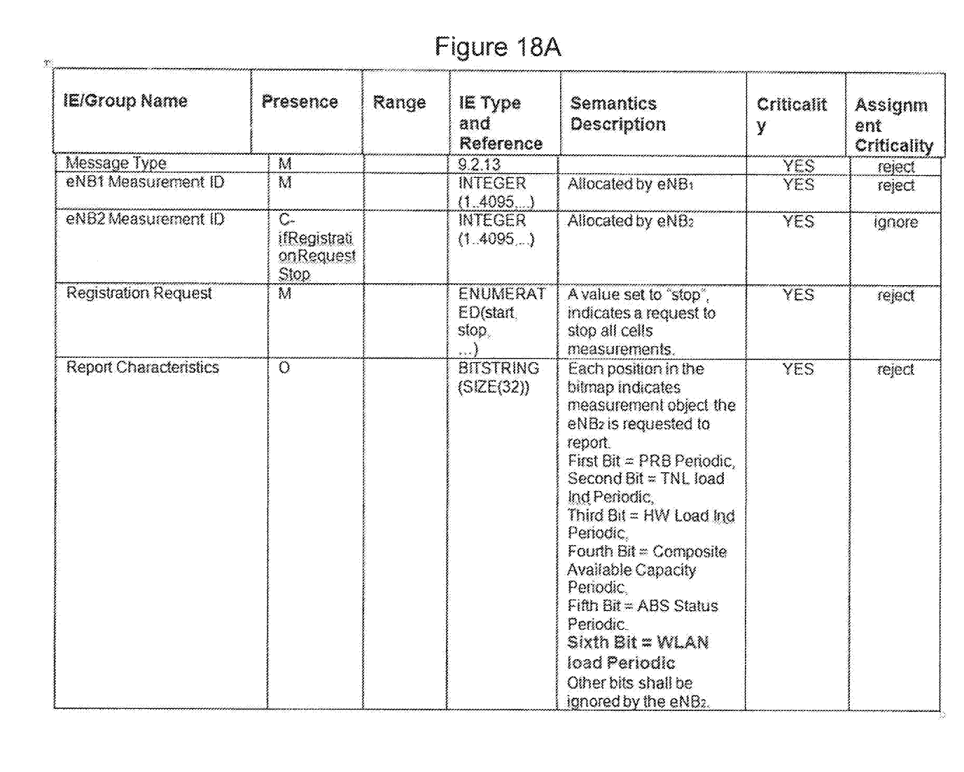

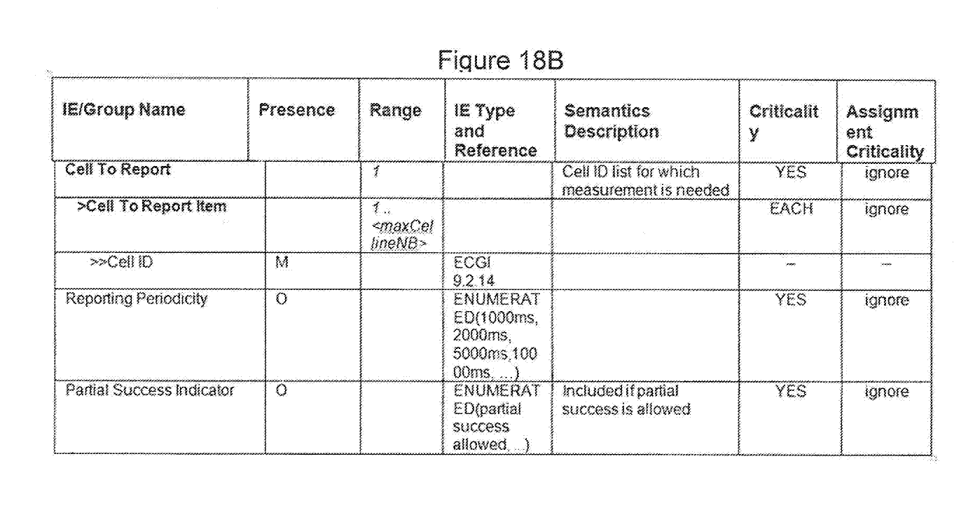

The information elements described in the table of FIG. 17 may be encoded in different ways, depending on choices taken in standardization. Moreover, the Cell Load IE might be specified in a way similar to the Composite Available Capacity IE defined in TS36.423 v11.5.0. Namely, the Cell Load IE may be formed by two IEs, one of which indicates the maximum capacity of the cell and the other indicating how much of such capacity is used at/or before the time the report is generated. The Cell Load would refer to the technology specified via the IEs illustrated in the table of FIGS. 18A and 18B.

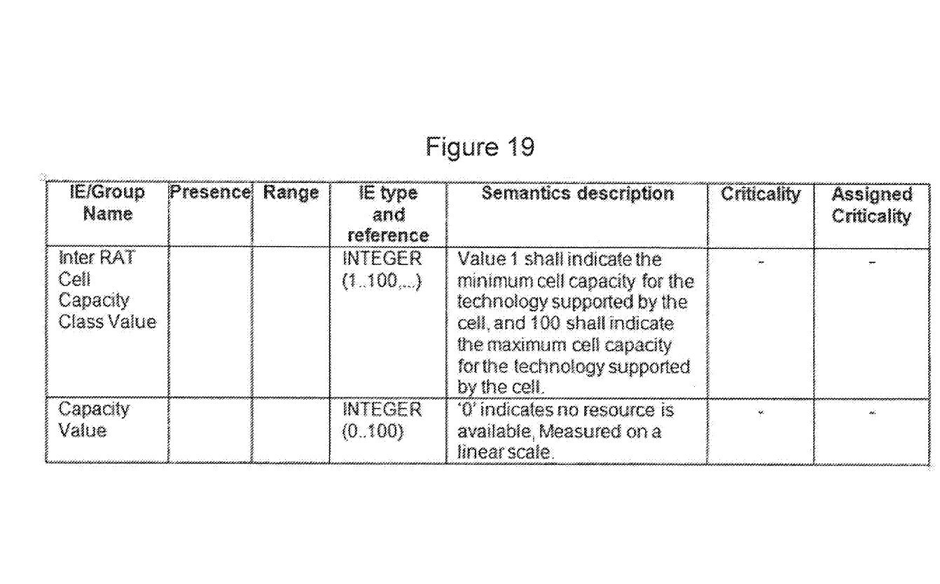

FIG. 19 is a table illustrating an example of a way to encode Cell Load IE.

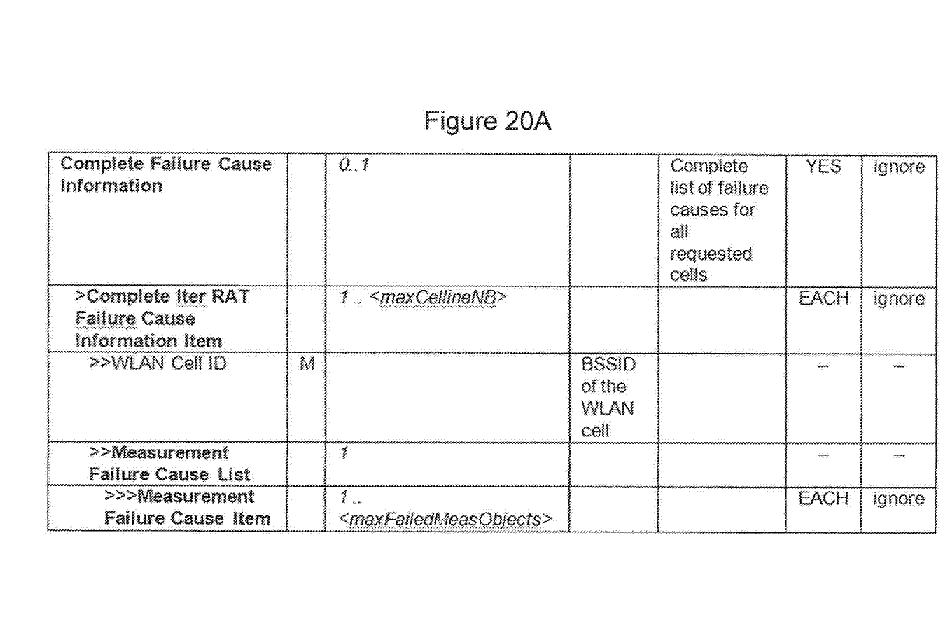

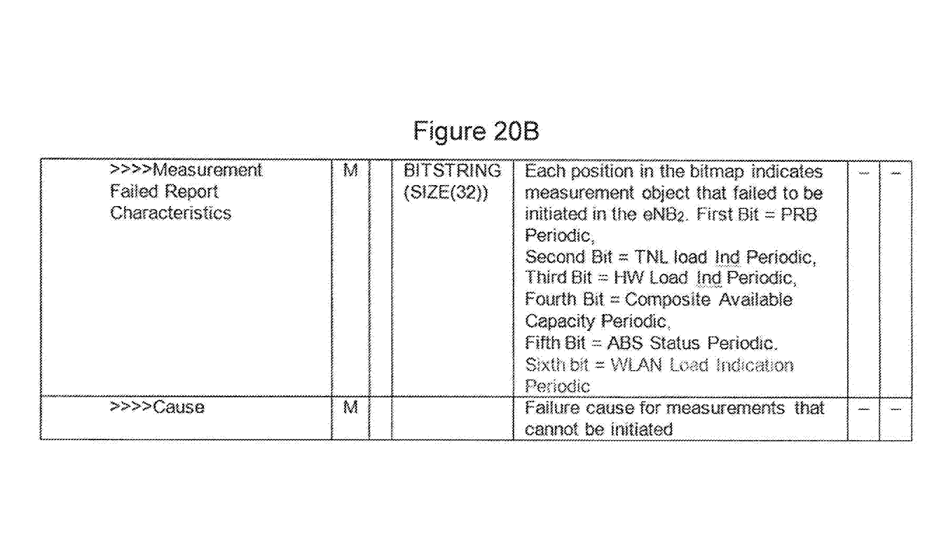

In case the load report procedure fails to be established for all the cells of other technology base stations requested, a RESOURCE STATUS FAILURE message can be sent, for example, similar to the RESOURCE STATUS FAILURE described in E-UTRAN TS 36.423 v11.5.0. Such a massage may include the IEs of FIGS. 20A and 20B which illustrates new IEs in the RESOURCE STATUS failure (including “Sixth bit=WLAN Load Indication Periodic”).

The message in the table of FIGS. 20A and 20B is only an example involving WLAN, and a same/similar method can be applied to different radio access technologies.

Procedures specified above for the example case of WLAN technologies could be also extended for other technologies, either in case a node, for example an eNB, is connected to another node of the same technology, for example another eNB, and such other node is connected to nodes of other technologies (both 3GPP based or not) or in case the first node is directly connected to other nodes supporting other technologies.

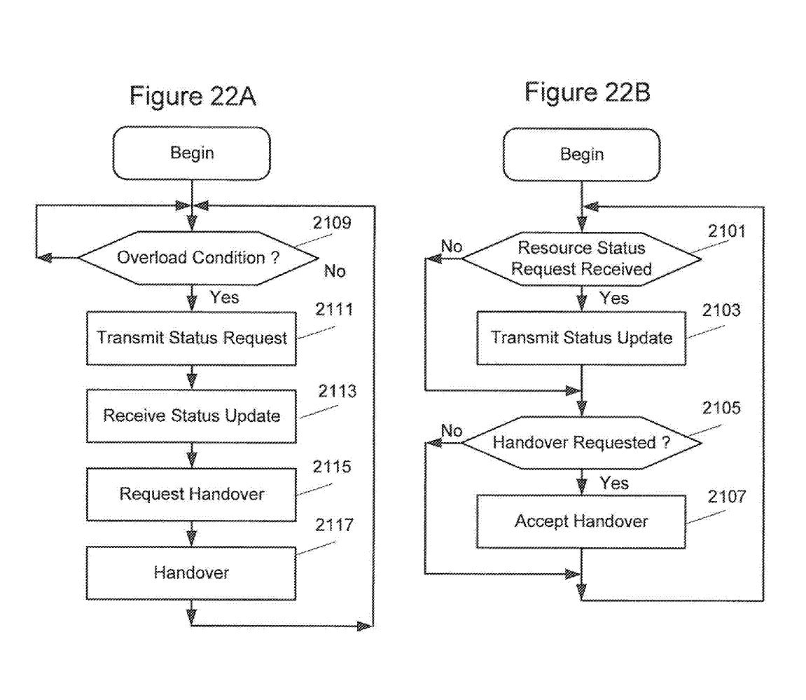

FIGS. 22A and 22B are flow charts illustrating base station operations according to some embodiments of inventive concepts. Each of base stations 100a, 100b, and 100c of FIG. 21, for example, may be a handover source base station (also referred to as a source base station or a source) performing operations discussed below with respect to FIG. 22A and/or a handover target base station (also referred to as a target base station or a target) performing operations discussed below with respect to FIG. 22B at different times depending on current/changing load/traffic conditions and/or other factors. Accordingly, the same base station (at different times) may transmit and receive status requests (at blocks 2111 and 2101), transmit and receive handover requests (blocks 2115 and 2105), transmit and receive status updates (blocks 2103 and 2113), and/or initiate and accept handovers (blocks 2117 and 2107). In the following discussion, base station 100a will be discussed by way of example as a handover source base station, and base stations 100b and/or 100c will be discussed a handover target base stations.

Responsive to a load of base station 100a exceeding a threshold (e.g., detecting an overload condition) at block 2109 of FIG. 22A, base station processor 101a may initiate handover operations (acting as a handover source base station). More particularly, base station processor 101a may transmit a resource status request message over the X2 interface to base station 100b and/or 100c at block 2111. At block 2113, base station processor 101a may receive a resource status update message from base station 100b and/or 100c (responsive to the resource status request message), and the resource status update message may include information regarding at least one wireless access point 111b and/or 111c providing service within a coverage area 121b and/or 121c of neighbor base station 100b and/or 100c. Responsive to receiving the resource status update message, base station processor 101a may select one of base station 100b and/or 100c as a target base station(s) for wireless terminal handover.

According to embodiments discussed above with respect to FIG. 8, for example, wireless terminals 111a-1 to 111a-x served by base station 100a may include a first plurality of wireless terminals that are WLAN capable and a second plurality of wireless terminals that are non-WLAN capable. Moreover, receiving the status update message at block 2113 may include receiving a first message (also referred to as a report) from a neighbor base station 100c including information identifying a wireless WLAN access point and receiving a second message (also referred to as a report) from neighbor base station 100b identifying no wireless WLAN access points. In this example, processor 101a may transmit handover request messages at block 2115 to neighbor base stations 100b and 100c to hand over the first plurality of wireless terminals that are WLAN capable to neighbor base station 100c and to hand over the second plurality of wireless terminals that are non-WLAN capable to neighbor base station 100b. At block 2117, base station processor 101a may proceed with the handover.

According to embodiments discussed above with respect to FIG. 9, wireless terminals 111a-1 to 111a-x served by base station 100a may include a first plurality of wireless terminals having a first WLAN capability (e.g., according to a first capability of the

WiFi standard) and a second plurality of wireless terminals having a second WLAN capability (e.g., according to a second capability of the WiFi standard) different than the first WLAN capability. Moreover, receiving the status update message at block 2113 may include receiving a first message (also referred to as a report) from neighbor base station 100c including information identifying a wireless WLAN access point supporting the first WLAN capability and receiving a second message (also referred to as a report) from neighbor base station 100b identifying a wireless WLAN access point supporting the second WLAN capability. In this example, processor 101a may transmit handover request messages at block 2115 to neighbor base stations 100b and 100c to hand over the first plurality of wireless terminals to neighbor base station 100c and to hand over the second plurality of wireless terminals to neighbor base station 100b. At block 2117, base station processor 101a may proceed with the handover.

According to some embodiments discussed above with respect to FIG. 10, wireless terminals 111a-1 to 111a-x served by base station 100a may include a first plurality of wireless terminals having a WLAN capability and a second plurality of wireless terminals having a WLAN capability. Moreover, receiving the status update message at block 2113 may include receiving a first message (also referred to as a report) from neighbor base station 100c including information identifying a wireless WLAN access point that is relatively lightly loaded and receiving a second message (also referred to as a report) from neighbor base station 100b identifying a wireless WLAN access point that is relatively heavily loaded. In this example, processor 101a may prioritize handing over the first plurality of wireless terminals to neighbor base station 100c. Accordingly, base station processor 101a may transmit a handover request message at block 2115 to neighbor base station 100c, and at block 2117, base station processor 101a may proceed with the handover to neighbor base station 100c.

According to some other embodiments discussed above with respect to FIG. 10, wireless terminals 111a-1 to 111a-x served by base station 100a may include a plurality of wireless terminals having a WLAN capability (e.g., a capability of the WiFi standard). Moreover, receiving the status update message at block 2113 may include receiving a first message (also referred to as a report) from neighbor base station 100c including information identifying a wireless WLAN access point that is relatively lightly loaded and receiving a second message (also referred to as a report) from neighbor base station 100b identifying a wireless WLAN access point that is relatively heavily loaded. In this example, processor 101a may prioritize handing over the plurality of wireless terminals to neighbor base station 100c. Accordingly, base station processor 101a may transmit a handover request message at block 2115 to neighbor base station 100c, and at block 2117, base station processor 101a may proceed with the handover to neighbor base station 100c.

Operations of a base station 100b operating as a handover target base station are illustrated in FIG. 22B. Responsive to receiving a status request message at block 2101 (transmitted from a handover source base station as discussed above with respect to block 2111 of FIG. 22A), base station processor 101b may transmit a status update message at block 2103 (received by the handover source base station as discussed above with respect to block 2113). Responsive to receiving a handover request at block 2105 (transmitted from the handover source base station as discussed above with respect to block 2115), base station processor 101b may accept the handover.

While not shown in FIGS. 22A and 22B, before transmitting a resource status update message at block 2103, handover target base station 100b may transmit a resource status response message responsive to the resource status request message (of blocks 2111 and 2101), and the resource status response message may be received by handover source base station 100a. In addition, the resource status request message (of blocks 2111 and 2101) may define a periodicity for transmit status update messages to be transmitted by target base station 100b after transmitting the resource status response message. After transmitting the resource status response message, handover target base station 100b may periodically transmit resource status update messages in accordance with the periodicity defined by the resource status request message. At block 2103, handover target base station 100b may thus transmit a plurality of periodic resource status update messages, and at block 2013, handover source base station 100a may receive the plurality of periodic resource status update messages. Responsive to each resource status update message, handover source base station 100a may determine if the handover target base station 100b is or is not overloaded and/or if some load can be transferred to the handover target base station 100b. Responsive to determining that the handover target base station 100b is not overloaded and/or that some load can be transferred to the handover target base station 100b, handover source base station 100a may select wireless terminals for handover, and handover source base station 100a may request and execute the handover at blocks 2115 and 2117, with the handover target base station 100b accepting the handover at blocks 2105 and 2107. If an overload condition persists at handover source base station 100a at block 2019 after executing handover at block 2117, operations of blocks 2111, 2113, 2115, 2117, 2101, 2103, 2105, and 2107 may be repeated. If the overload condition has been mitigated at handover source base station 100a, the resource status exchange from base station 100b may be stopped by transmitting a resource status request with a stop code from base station 100a to base station 100b.

In embodiments discussed above, base stations 100a, 100b, and 100c may operate according to a first radio access technology, such as Long Term Evolution (LTE), and wireless access points 111a, 111b, and 111c may operate according to a second radio access technology, such as a WLAN access point technology (e.g., WiFi).

As discussed above, status update messages may be transmitted at block 2103 and/or received at block 2113 including information regarding at least one wireless access point providing service within a coverage area of a respective base station that transmitted the message. For example, information regarding the wireless access point may include one or more of: a location of a wireless access point providing service within a coverage area of the respective base station; a capacity and/or bandwidth of a wireless access point providing service within a coverage area of the respective base station; an extended service set identifier for a wireless access point providing continuous service; an operating frequency and/or channel number of a wireless access point providing service within a coverage area of the respective base station; an identifier for a wireless access point providing service within a coverage area of the respective base station; and/or a load (e.g., a wireless terminal population and/or data traffic level) being serviced by a wireless access point providing service within a coverage area of the respective base station.

Advantages of Some Embodiments of Inventive Concepts

Embodiments of inventive concepts may provide methods to exchange load information between nodes of different radio access technologies. The exchange can occur either between two nodes of the same technology such as LTE, where one or both of such nodes are connected to other nodes of different technologies or it can happen directly via nodes of different technologies.

With the signaling mechanisms proposed herein, it may be possible to improve/optimize load balancing procedures by forcing UEs to move into coverage areas where other access technologies matching UE capabilities are available.

This may reduce network congestion and/or provide increased QoS (Quality of Service) and user experience to the users.

### Abbreviations

AP Access Point

BSS Basic Service Set

BSSID Basic Service Set Identifier

CAC Composite available capacity

CR Cell Reselection

CT Core network and Terminals

DL Downlink

DM Domain Manager

EUTRAN Evolved UTRAN

GBR Guaranteed Bit Rate

GERAN GSM EDGE Radio Access Network

GSM Global System for Mobile Communications

HW Hardware

IE Information Element

L3 Layer 3

MO Management Object

MLB Mobility Load Balance

NE Node element

NM Network Manager

OAM Operation and Maintenance

OSS Operation and Support System

PRB Primary Resource Block

PS Packet Switched

QoS Quality of Service

RAN Radio Access Network

RRC Radio Resource Control

RSSI received signal strength indicator

SA System Architecture

SON Self-Organizing Network

STA Station

TNL Transport Network Level

UL Uplink

UMTS Universal Mobile Telecommunications System

WAN Wide Area Network

WCDMA Wideband Code Division Multiple Access

X2AP X2 Application Protocol

WLAN Wireless Local Area Network

3GPP 3rd Generation Partnership Project

CN Core Network

UTRAN Universal Terrestrial Radio Access Network

GERAN GSM EDGE Radio Access Network

HO Hand Over

MRO Mobility Robustness Optimization

IRAT inter-RAT

LTE Long Term Evolution

RAT Radio Access Technology

eNB evolved Node B

RNC Radio Network Controller

UE User Equipment

RSRP Reference Signal Received Power

RSRQ Reference Signal Received Quality

### LIST OF REFERENCES

RP-122037, “Study on Next Generation SON for UTRA and LTE”

RP-122038: New Study Item Proposal on WLAN/3GPP Radio Interworking, Intel Corporation

TS 36.423 v11.5.0 “X2 application protocol (X2AP)” (Release 11)

“Part 11: Wireless LAN Medium Access Control (MAC) and Physical Layer (PHY) Specifications”, IEEE Std. 802.11-2012, IEEE Computer Society

3GPP TS 23.402v12.1.0, Architecture enhancements for non-3GPP accesses

3GPP TS 24.312v12.1.0, Access Network Discovery and Selection Function (ANDSF) Management Object (MO)

3GPP TR 37.834 Study on WLAN/3GPP Radio Interworking (Release 12)

### EXAMPLE EMBODIMENTS

### Embodiment 1

A method of operating a source base station of a radio access network providing wireless communications for a plurality of wireless terminals, the method comprising:
receiving at the source base station information regarding at least one wireless access point providing service within a coverage area of at least one neighbor base station of the radio access network.

### Embodiment 2

The method of Embodiment 1 further comprising:
handing over one or more of the plurality of wireless terminals from the source base station to the at least one neighbor base station based on the information regarding the at least one wireless access point.

### Embodiment 3

The method of Embodiment 2 wherein handing over comprises handing over one or more of the plurality of wireless terminals from the source base station to the at least one neighbor base station based on the information regarding the at least one wireless access point responsive to a load of the source base station exceeding a threshold.

### Embodiment 4

The method of any of Embodiments 1-3 wherein receiving the information comprises receiving the information from the at least one neighbor base station of the radio access network.

### Embodiment 5

The method of any of Embodiments 2-4 wherein the plurality of wireless terminals includes a first plurality of wireless terminals that are WLAN capable and a second plurality of wireless terminals that are non-WLAN capable, wherein receiving the information includes receiving a first report from a first neighbor base station including information identifying a wireless WLAN access point and receiving a second report form a second neighbor base station identifying no wireless WLAN access points, and wherein handing over comprises handing over the first plurality of wireless terminals that are WLAN capable to the first neighbor base station and handing over the second plurality of wireless terminals that are non-WLAN capable to the second neighbor base station.

### Embodiment 6

The method of any of Embodiments 2-4 wherein the plurality of wireless terminals includes a first plurality of wireless terminals having a first WLAN capability (e.g., according to a first capability of the WiFi standard) and a second plurality of wireless terminals having a second WLAN capability (e.g., according to a second capability of the WiFi standard) different than the first WLAN capability, wherein receiving the information includes receiving a first report from a first neighbor base station including information identifying a wireless WLAN access point supporting the first WLAN capability and receiving a second report form a second neighbor base station identifying a wireless WLAN access point supporting the second WLAN capability, and wherein handing over comprises handing over the first plurality of wireless terminals to the first neighbor base station and handing over the second plurality of wireless terminals to the second neighbor base station.

### Embodiment 7

The method of any of Embodiments 2-4 wherein the plurality of wireless terminals includes a first plurality of wireless terminals having a first WLAN capability (e.g., according to a first WiFi standard) and a second plurality of wireless terminals having a second WLAN capability (e.g., according to a second WiFi standard) different than the first WLAN capability, wherein receiving the information includes receiving a first report from a first neighbor base station including information identifying a wireless WLAN access point that is lightly loaded and receiving a second report from a second neighbor base station identifying a wireless WLAN access point that is heavily loaded, and wherein handing over comprises prioritizing handing over the first plurality of wireless terminals to the first neighbor base station.

### Embodiment 8

The method of any one of Embodiments 1-7 wherein the information regarding the at least one wireless access point comprises a location of a wireless access point providing service within the coverage area of the neighbor base station.

### Embodiment 9

The method of any one of Embodiments 1-8 wherein the information regarding the at least one wireless access point comprises a capacity and/or bandwidth of a wireless access point providing service within the coverage area of the neighbor base station.

### Embodiment 10

The method of any one of Embodiments 1-9 wherein the information regarding the at least one wireless access point comprises an extended service set identifier for a plurality of wireless access points providing continuous service.

### Embodiment 11

The method of any one of Embodiments 1-10 wherein the information regarding the at least one wireless access point comprises an operating frequency and/or channel number of a wireless access point providing service within the coverage area of the neighbor base station.

### Embodiment 12

The method of any one of Embodiments 1-11 wherein the information regarding the at least one wireless access point comprises an identifier for a wireless access point providing service within the coverage area of the neighbor base station.

### Embodiment 13

The method of any one of Embodiments 1-12 wherein the information regarding the at least one wireless access point comprises a load (e.g., a wireless terminal population and/or data traffic level) being serviced by a wireless access point providing service within the coverage area of the neighbor base station.

### Embodiment 14

The method of any one of Embodiments 1-13 wherein radio access network comprises a Long Term Evolution (LTE) radio access network, wherein the source base station comprises a first LTE eNodeB base station, and wherein the neighbor base station comprises a second LTE eNodeB base station.

### Embodiment 15

The method of any one of Embodiments 1-14 wherein the at least one wireless access point comprises at least one WLAN access point.

### Embodiment 16

The method of any one of Embodiments 1-15 further comprising: transmitting a report to the neighbor base station wherein the report includes information regarding at least one wireless access point providing service within a coverage area of the source base station.

### Embodiment 17

The method of any of Embodiments 1-16 further comprising:
transmitting information regarding at least one wireless access point providing service within a coverage area of the source base station to another base station of the radio access network.

### Embodiment 18

A method of operating a source base station of a radio access network providing wireless communications for a plurality of wireless terminals, the method comprising:
handing over one or more of the plurality of wireless terminals from the source base station to at least one neighbor base station based on information regarding at least one wireless access point providing service within a coverage area of the at least one neighbor base station.

### Embodiment 19

The method of Embodiment 18 further comprising:
receiving the information regarding the at least one wireless access point from the at least one neighbor base station of the radio access network.

### Embodiment 20

The method of any of Embodiments 18-19 wherein handing over comprises handing over one or more of the plurality of wireless terminals from the source base station to the at least one neighbor base station responsive to a load of the source base station exceeding a threshold and responsive to the information regarding the at least one wireless access point.

### Embodiment 21

The method of any of Embodiments 18-20 further comprising:
transmitting information regarding at least one wireless access point providing service within a coverage area of the source base station to another base station of the radio access network.

### Embodiment 22

A base station of a radio access network, the base station comprising:
a transceiver configured to provide communications for a plurality of wireless terminals in a coverage area of the base station;
a processor coupled to the transceiver wherein the processor is configured to receive information regarding at least one wireless access point providing service within a coverage area of at least one neighbor base station of the radio access network; and
memory coupled to the processor wherein the memory is configured to store the information regarding the at least one wireless access point providing service within the coverage area of the at least one neighbor base station.

### Embodiment 23

The base station of Embodiment 22 wherein the processor is further configured to hand over one or more of the plurality of wireless terminals from the base station to the at least one neighbor base station based on the information regarding the at least one wireless access point.

### Embodiment 24

The base station of Embodiment 23 wherein the processor is configured to hand over one or more of the plurality of wireless terminals from the base station to the at least one neighbor base station based on the information regarding the at least one wireless access point responsive to a load of the base station exceeding a threshold.

### Embodiment 25

The base station of any of Embodiments 22-24 wherein the processor is configured to receive the information from the at least one neighbor base station of the radio access network (e.g., over an X2 interface).

### Embodiment 26

The base station of any of Embodiments 22-25 wherein the plurality of wireless terminals includes a first plurality of wireless terminals that are WLAN capable and a second plurality of wireless terminals that are non-WLAN capable, wherein the processor is configured to receive a first report from a first neighbor base station including information identifying a wireless WLAN access point and to receive a second report from a second neighbor base station identifying no wireless WLAN access points, and wherein the processor is configured to hand over the first plurality of wireless terminals that are WLAN capable to the first neighbor base station and to hand over the second plurality of wireless terminals that are non-WLAN capable to the second neighbor base station.

### Embodiment 27

The base station of any of Embodiments 22-25 wherein the plurality of wireless terminals includes a first plurality of wireless terminals having a first WLAN capability (e.g., according to a first capability of the WiFi standard) and a second plurality of wireless terminals having a second WLAN capability (e.g., according to a second capability of the WiFi standard) different than the first WLAN capability, wherein the processor is configured to receive a first report from a first neighbor base station including information identifying a wireless WLAN access point supporting the first WLAN capability and to receive a second report form a second neighbor base station identifying a wireless WLAN access point supporting the second WLAN capability, and wherein the processor is configured to hand over the first plurality of wireless terminals to the first neighbor base station and to hand over the second plurality of wireless terminals to the second neighbor base station.

### Embodiment 28

The base station of any of Embodiments 22-25 wherein the plurality of wireless terminals includes a first plurality of wireless terminals having a first WLAN capability (e.g., according to a first WiFi standard) and a second plurality of wireless terminals having a second WLAN capability (e.g., according to a second WiFi standard) different than the first WLAN capability, wherein the processor is configured to receive a first report from a first neighbor base station including information identifying a wireless WLAN access point that is lightly loaded and to receive a second report form a second neighbor base station identifying a wireless WLAN access point that is heavily loaded, and wherein the processor is configured prioritizing handing over the first plurality of wireless terminals to the first neighbor base station.

### Embodiment 29

A base station of a radio access network, the base station comprising:
a transceiver configured to provide communications for a plurality of wireless terminals in a coverage area of the base station; and
a processor coupled to the transceiver wherein the processor is configured to hand over one or more of the plurality of wireless terminals from the base station to at least one neighbor base station based on information regarding at least one wireless access point providing service within a coverage area of the at least one neighbor base station.

### Embodiment 30

The base station of Embodiment 29 wherein the processor is further configured to receive the information regarding the at least one wireless access point from the at least one neighbor base station of the radio access network.

### Embodiment 31

The base station of any of Embodiments 29-30 wherein the processor is configured to hand over one or more of the plurality of wireless terminals from the base station to the at least one neighbor base station responsive to a load of the base station exceeding a threshold and responsive to the information regarding the at least one wireless access point.

### Embodiment 32

The base station of any of Embodiments 29-31 wherein the processor is further configured to transmit information regarding at least one wireless access point providing service within a coverage area of the base station to another base station of the radio access network.

Further Definitions:

When an element is referred to as being “connected”, “coupled”, “responsive”, or variants thereof to another element, it can be directly connected, coupled, or responsive to the other element or one or more intervening elements may be present. In contrast, when an element is referred to as being “directly connected”, “directly coupled”, “directly responsive”, or variants thereof to another element, there are no intervening elements present. Like numbers refer to like nodes/elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or”, abbreviated “/”, includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but do not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. Examples of embodiments of aspects of present inventive concepts explained and illustrated herein include their complimentary counterparts. The same reference numerals or the same reference designators denote the same or similar elements throughout the specification.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Other network elements, communication devices and/or methods according to embodiments of inventive concepts will be or become apparent to one with skill in the art upon review of the present drawings and description. It is intended that all such additional network elements, devices, and/or methods be included within this description, be within the scope of the present inventive concepts. Moreover, it is intended that all embodiments disclosed herein can be implemented separately or combined in any way and/or combination.

Many variations and modifications can be made to the embodiments without substantially departing from the principles of present inventive concepts. All such variations and modifications are intended to be included herein within the scope of present inventive concepts. Accordingly, the above disclosed subject matter is to be considered illustrative, and not restrictive, and the appended claims are intended to cover all such modifications, enhancements, and other embodiments, which fall within the spirit and scope of present inventive concepts.

1. A method of operating a source base station of a radio access network providing wireless communications for a plurality of wireless terminals, the method comprising:
receiving at the source base station information regarding at least one wireless access point providing service within a coverage area of at least one neighbor base station of the radio access network.

2. The method of claim 1 further comprising:
handing over one or more of the plurality of wireless terminals from the source base station to the at least one neighbor base station based on the information regarding the at least one wireless access point.

3. The method of claim 2 wherein handing over comprises handing over one or more of the plurality of wireless terminals from the source base station to the at least one neighbor base station based on the information regarding the at least one wireless access point responsive to a load of the source base station exceeding a threshold.

4. The method of claim 1 wherein receiving the information comprises receiving the information from the at least one neighbor base station of the radio access network.

5. The method of claim 2 wherein the plurality of wireless terminals includes a first plurality of wireless terminals that are WLAN capable and a second plurality of wireless terminals that are non-WLAN capable, wherein receiving the information includes receiving a first report from a first neighbor base station including information identifying a wireless WLAN access point and receiving a second report from a second neighbor base station identifying no wireless WLAN access points, and wherein handing over comprises handing over the first plurality of wireless terminals that are WLAN capable to the first neighbor base station and handing over the second plurality of wireless terminals that are non-WLAN capable to the second neighbor base station.

6. The method of claim 2 wherein the plurality of wireless terminals includes a first plurality of wireless terminals having a first WLAN capability and a second plurality of wireless terminals having a second WLAN capability different than the first WLAN capability, wherein receiving the information includes receiving a first report from a first neighbor base station including information identifying a wireless WLAN access point supporting the first WLAN capability and receiving a second report from a second neighbor base station identifying a wireless WLAN access point supporting the second WLAN capability, and wherein handing over comprises handing over the first plurality of wireless terminals to the first neighbor base station and handing over the second plurality of wireless terminals to the second neighbor base station.

7. The method of claim 2 wherein the plurality of wireless terminals include wireless terminals that have a WLAN capability, receiving the information includes receiving a first report from a first neighbor base station including information identifying a first wireless WLAN access point and receiving a second report from a second neighbor base station identifying a second wireless WLAN access point, wherein a reported load of the second WLAN access point is higher than a reported load of the first WLAN access point, and wherein handing over comprises prioritizing handing over the wireless terminals that have the WLAN capability to the first neighbor base station.

8. The method of claim 1 wherein the information regarding the at least one wireless access point comprises a location of a wireless access point providing service within the coverage area of the at least one neighbor base station.

9. The method of claim 1 wherein the information regarding the at least one wireless access point comprises a capacity and/or bandwidth of a wireless access point providing service within the coverage area of the at least one neighbor base station.

10. The method of claim 1 wherein the information regarding the at least one wireless access point comprises an extended service set identifier for a plurality of wireless access points providing continuous service.

11. The method of claim 1 wherein the information regarding the at least one wireless access point comprises an operating frequency and/or channel number of a wireless access point providing service within the coverage area of the at least one neighbor base station.

12. The method of claim 1 wherein the information regarding the at least one wireless access point comprises an identifier for a wireless access point providing service within the coverage area of the at least one neighbor base station.

13. The method of claim 1 wherein the information regarding the at least one wireless access point comprises a load being serviced by a wireless access point providing service within the coverage area of the at least one neighbor base station.

14. The method of claim 1 wherein the radio access network comprises a Long Term Evolution, LTE, radio access network, wherein the source base station comprises a first LTE eNodeB base station, and wherein the at least one neighbor base station comprises a second LTE eNodeB base station.

15. The method of claim 1 wherein the at least one wireless access point comprises at least one WLAN access point.

16. The method of claim 1 further comprising:
transmitting information regarding at least one wireless access point providing service within a coverage area of the source base station to another base station of the radio access network.

17. The method of claim 1 wherein the source base station and the at least one neighbor base station operate according to a first radio access technology while the at least one wireless access point operates according to a second radio access technology.

18. A method of operating a source base station of a radio access network providing wireless communications for a plurality of wireless terminals, the method comprising:
handing over one or more of the plurality of wireless terminals from the source base station to at least one neighbor base station based on information regarding at least one wireless access point providing service within a coverage area of the at least one neighbor base station.

19. A base station of a radio access network, the base station comprising:
a transceiver configured to provide communications for a plurality of wireless terminals in a coverage area of the base station;
a processor coupled to the transceiver wherein the processor is configured to receive information regarding at least one wireless access point providing service within a coverage area of at least one neighbor base station of the radio access network; and
memory coupled to the processor wherein the memory is configured to store the information regarding the at least one wireless access point providing service within the coverage area of the at least one neighbor base station.

20. The base station of claim 19 wherein the processor is further configured to hand over one or more of the plurality of wireless terminals from the base station to the at least one neighbor base station based on the information regarding the at least one wireless access point.

21. The base station of claim 20 wherein the processor is configured to hand over one or more of the plurality of wireless terminals from the base station to the at least one neighbor base station based on the information regarding the at least one wireless access point responsive to a load of the base station exceeding a threshold.

22. The base station of claim 19 wherein the processor is configured to receive the information from the at least one neighbor base station of the radio access network.

23. The base station of claim 19 wherein the plurality of wireless terminals includes a first plurality of wireless terminals that are WLAN capable and a second plurality of wireless terminals that are non-WLAN capable, wherein the processor is configured to receive a first report from a first neighbor base station including information identifying a wireless WLAN access point and to receive a second report from a second neighbor base station identifying no wireless WLAN access points, and wherein the processor is configured to hand over the first plurality of wireless terminals that are WLAN capable to the first neighbor base station and to hand over the second plurality of wireless terminals that are non-WLAN capable to the second neighbor base station.

24. The base station of claim 19 wherein the plurality of wireless terminals includes a first plurality of wireless terminals having a first WLAN capability and a second plurality of wireless terminals having a second WLAN capability different than the first WLAN capability, wherein the processor is configured to receive a first report from a first neighbor base station including information identifying a wireless WLAN access point supporting the first WLAN capability and to receive a second report from a second neighbor base station identifying a wireless WLAN access point supporting the second WLAN capability, and wherein the processor is configured to hand over the first plurality of wireless terminals to the first neighbor base station and to hand over the second plurality of wireless terminals to the second neighbor base station.

25. The base station of claim 19 wherein the plurality of wireless terminals includes wireless terminals that have a WLAN capability, wherein the processor is configured to receive a first report from a first neighbor base station including information identifying a first wireless WLAN access point and to receive a second report from a second neighbor base station identifying a second wireless WLAN access point, wherein a reported load of the second WLAN access point is higher than a reported load of the first WLAN access point, and wherein the processor is configured to prioritize handing over the wireless terminals that have the WLAN capability to the first neighbor base station.

26. A base station of a radio access network, the base station comprising:
a transceiver configured to provide communications for a plurality of wireless terminals in a coverage area of the base station; and
a processor coupled to the transceiver wherein the processor is configured to hand over one or more of the plurality of wireless terminals from the base station to at least one neighbor base station based on information regarding at least one wireless access point providing service within a coverage area of the at least one neighbor base station.

27.-44. (canceled)
